(19) United States
(12) Patent Application Publication
(10) Pub. No.: US 2009/0311540 A1
(43) Pub. Date: Dec. 17, 2009

(54) Highly Sensitive and Selective Nano-Structured Grafted Polymer Layers

(76) Inventors: Yoram Cohen, Los Angeles, CA (US); Gregory T. Lewis, Los Angeles, CA (US)

Correspondence Address: COOLEY GODWARD KRONISH LLP;ATTN: Patent Group, Suite 1100, 777 6th Street, NW, Washington, DC, 20001, US

(21) Appl. No.: 12/482,272

(22) Filed: Jun. 10, 2009

Related U.S. Application Data
(60) Provisional application No. 61/060,777, filed on Jun. 11, 2008.

(51) Int. Cl. B32B 27/06; H05H 1/00

(52) U.S. Cl. 428/447; 427/535

(57) ABSTRACT

In one embodiment, a method of modifying a surface of a substrate includes activating the surface of the substrate, and polymerizing the surface of the substrate. The polymerizing including subjecting the surface of the substrate to a monomer solution at a temperature of between 105° C. and 130° C. for a first period of time and subjecting the surface of the substrate to the monomer solution at a temperature of between 70° C. and 90° C. for a second period of time different than the first period of time. In another embodiment, a method of modifying a surface of a substrate includes activating the surface of the substrate, and graft polymerizing a vinyl monomer onto the surface of the substrate. The polymerizing including subjecting the surface of the substrate to a mixture including a monomer solution and 2,2,6,6-tetramethyl-1-piperidinyloxy at a concentration of between 5 and 20 mM. In another embodiment, an apparatus includes a substrate having a surface. The surface has a set of polymers terminally graphed thereon. The apparatus being configured to sorb a chemical solute. The terminally grafter polymer layer being formed on the surface of the substrate by a controlled graft polymerization process.

### CROSS REFERENCE TO RELATED APPLICATION

This application claims the benefit of U.S. Provisional Application Ser. No. 61/060,777, entitled “Highly Sensitive and Selective Nano-Structured Grafted Polymer Layers for Chemical Sensors,” filed on Jun. 11, 2008, the disclosure of which is incorporated herein by reference in its entirety.

### FIELD OF THE INVENTION

The invention relates to highly sensitive and selective thin polymeric film sensing layers and processes for making the same.

### BACKGROUND

Previous approaches on surface graft polymerization have been typically achieved by initiation of graft polymerization or polymer grafting using chemical initiators in solution to initiate reactive surface sites or grafting of surface initiators. For organic, polymeric, or inorganic surfaces, resulting surface density of polymer chains by the above approaches can be limited by steric hindrance associated with the binding of large molecular weight polymer chains (formed in solution) to the active surface sites (i.e., polymer grafting) which would prevent a dense polymer brush layer.

A variety of techniques were developed to directly activate the membrane surface to reduce polymer grafting such as gamma irradiation. Gamma irradiation has been studied but specific effects on surface density have not been reported. It is generally difficult to control the degree of surface activation, and the required high-energy gamma irradiation leads to surface etching. Moreover, the above techniques typically involve the use of a radioactive source which reduces the commercial attractiveness of the techniques, especially for large scale deployment.

In addition, other known approaches discuss graft polymerization techniques to create conductive polymeric sensing layers for the detection of chemical organic vapors, ambient humidity, and ions in solution, by utilizing graft polymerization sensor technology. In these applications, graft polymerization or polymer grafting of pre-formed chains is used to functionalize a conductive substrate (e.g., carbon black particles or flat substrate). Graft polymerization of carbon nanotubes (CNT) has also been studied to create amperometric sensor devices for the detection of organic vapors. In these approaches, graft polymerization or polymer grafting of pre-formed chains is used to functionalize a carbon nanotube. In some other approaches, radiation-initiated graft polymerization has been used to create conductive sensors by grafting polyethylene on carbon black surfaces. However, in these approaches, the substrates may be limited to carbon black conductive surfaces and carbon nanotube conductive surfaces, the graft polymerization technique can involve chemical initiators and radiation grafting, and the surfaces may not undergo plasma surface activation and graft polymerization.

### SUMMARY

In contrast with the known approaches, in some embodiments, the disclosed technique of graft polymerization, induced by plasma surface treatment, has the advantage of the formation of a high density of surface initiation sites which allows polymer chain growth directly from the surface, while minimizing bulk polymer growth. The polymer layer formed is a highly dense bush or brush layer with a more uniform distribution of polymer chain sizes than typically achieved by previous approaches, primarily due to the suppression of polymer grafting from solution. In addition, plasma surface initiation can be achieved over a short treatment interval to reduce the effects of surface etching. Use of low pressure plasma (i.e., under vacuum) treatment can limit the potential commercial scale applicability of the approach. In contrast, some embodiments of the invention can make use of an atmospheric pressure plasma source, thereby enabling surface treatment for subsequent graft polymerization of the sensing surface using either solution or gas phase reaction to create a terminally anchored polymer brush layer on the sensor surface.

In one embodiment, a method of modifying a surface of a substrate includes activating the surface of the substrate, and polymerizing the surface of the substrate. The polymerizing including subjecting the surface of the substrate to a monomer solution at a temperature of between 105° C. and 130° C. for a first period of time and subjecting the surface of the substrate to the monomer solution at a temperature of between 70° C. and 90° C. for a second period of time different than the first period of time.

In another embodiment, a method of modifying a surface of a substrate includes activating the surface of the substrate, and graft polymerizing a vinyl monomer onto the surface of the substrate. The polymerizing including subjecting the surface of the substrate to a mixture including a monomer solution and 2,2,6,6-tetramethyl-1-piperidinyloxy at a concentration of between 5 and 20 mM.

In another embodiment, an apparatus includes a substrate having a surface. The surface has a set of polymers terminally graphed thereon. The apparatus being configured to sorb a chemical solute. The terminally grafter polymer layer being formed on the surface of the substrate by a controlled graft polymerization process.

### BRIEF DESCRIPTION OF THE DRAWINGS

For a better understanding of the nature and objects of some embodiments of the invention, reference should be made to the following detailed description taken in conjunction with the accompanying drawings.

FIG. 1 is a flow chart of a process for plasma-induced graft polymerization according to an embodiment of the invention.

FIG. 2 is a schematic illustration of the surface activation according to one embodiment of the invention.

FIGS. 3A-3C are plots illustrating the absorbance various substrate surfaces modified according to embodiments of the invention.

FIG. 4 illustrates a process for controlling the polymerization according to one embodiment of the invention.

FIG. 5 is a plot of the Attenuated Total Reflectance (ATR) Fourier Transform Infrared Spectroscopy (FTIR) of a polystyrene grafted silicon surface by APPI-FRGP according to an embodiment of the invention.

FIG. 6 illustrates the relative polymer thickness achieved by APPI-FRGP at an initial monomer concentration of [M]ₒ=0.87 to 4.36 M (10 to 50 vol %) at T=85° C. after an 8 hour reaction period (L₃₀=film thickness at 30 vol %) according to an embodiment of the invention. Plasma surface activation conditions included a treatment time of 10 s, RF power of 40 W, and RH of 50% at 22° C.

FIGS. 7A and 7B illustrate polymer layer growth by APPI-FRGP at T=70° C., 85° C., and 100° C. according to an embodiment of the invention. FIG. 7A is at [M]ₒ=2.62 M, and FIG. 7B is at [M]ₒ=4.36 M. Plasma surface activation conditions were the same as for FIG. 6.

FIGS. 8A and 8B illustrate film growth rate versus reaction time for APPI-FRGP at T=70° C., 85° C., and 100° C. according to an embodiment of the invention. FIG. 8A is at [M]ₒ=2.62 M, and FIG. 8B is at [M]ₒ=4.36 M. Plasma surface activation conditions were the same as for FIG. 6.

FIG. 9 illustrates film thickness achieved by the APPI-FRGP rapid initiation approach according to an embodiment of the invention, illustrating Step 1 time interval (at 100° C.) range between 5 to 30 min with a Step 2 time (at 85° C.) of 3 h. Plasma surface activation conditions were the same as for FIG. 6.

FIG. 10 illustrates polymer layer growth at [M]ₒ=2.62 M for the a) APPI-FRGP rapid initiation approach (Step 1=15 min) and b) APPI-FRGP without rapid initiation at T=85° C. Plasma surface activation conditions were the same as for FIG. 6.

FIG. 11 illustrates controlled APPI-FRGP film thickness with time for [M]ₒ=4.36 M and [TEMPO]=5 to 15 mM at T=120° C. according to an embodiment of the invention. Plasma surface activation conditions were the same as for FIG. 6.

FIGS. 12A-12C are AFM images illustrating surface features according to one embodiment of the invention.

FIGS. 13A-13F illustrate tapping mode AFM surface images (1×1 μm²) of polystyrene grafted silicon by APPI-FRGP according to embodiments of the invention. FIG. 13A is at [M]ₒ=2.62 M and T=70° C. FIG. 13B is at [M]ₒ=2.62 M and T=85° C. FIG. 13C is at [M]ₒ=2.62 M and T=100° C. FIG. 13D is at [M]ₒ=4.36 M and T=70° C. FIG. 13E is at [M]ₒ=4.36 M and T=85° C. FIG. 13F is at [M]ₒ=4.36 M and T=100° C.

FIGS. 14A-14E illustrate tapping mode AFM images (1×1 μm²) of polystyrene grafted silicon by APPI-FRGP at [M]ₒ=4.36 M and 120° C. according to embodiments of the invention. FIG. 14A is for [TEMPO] of 5 mM. FIG. 14B is for [TEMPO] of 10 mM. FIG. 14C is for [TEMPO] of 15 mM. FIG. 14D is for surface image of [TEMPO]=10 mM. FIG. 14E is polymer feature height histogram with a fitted Gaussian distribution.

FIGS. 15A-15C are polymer feature height histograms with fitted Gaussian distributions for polystyrene grafted silicon created by APPI-FRGP at [M]₀=2.62 M according to embodiments of the invention. FIG. 15A is at T=70° C. FIG. 15B is at T=85° C. FIG. 15C is at T=100° C.

FIGS. 16A-16C are polymer feature height histograms with fitted Gaussian distributions for polystyrene grafted silicon created by APPI-FRGP at [M]₀=4.36M according to embodiments of the invention. FIG. 16A is at T=70° C. FIG. 16B is at T=85° C. FIG. 16C is at T=100° C.

FIG. 17 illustrates a multi-step surface preparation and AP plasma-induced graft polymerization process for a QCM mass-detection device according to an embodiment of the invention.

FIG. 18 illustrates a chemical vapor mass detection system with a sensor chamber, a QCM, penetrant storage vessel, and a carrier gas inlet according to an embodiment of the invention.

FIG. 19 illustrates a polystyrene film thickness versus reaction time for a) APPI-HLT-FRGP at M₀=30 vol % with Step 1 time of 20 min at 110° C. and Step 2 time at 85° C. and b) controlled APPI-NMGP at M₀=50 vol % at T=120° C. and TEMPO=20 mM according to an embodiment of the invention.

FIGS. 20A-20C are AFM surface images (1×1 μm²) of amorphous silicon QCM surfaces modified by (a) spin-coated polystyrene, (b) APPI-HLT-FRGP, and (c) controlled APPI-NMGP.

FIGS. 21A-21C are surface feature height histograms of amorphous silicon QCM surfaces modified by (a) spin-coated polystyrene, (b) APPI-HLT-FRGP, and (c) controlled APPI-NMGP, respectively.

FIG. 22 illustrates a characteristic sorption-desorption curve for penetrant sorption and diffusion in a polymer layer according to an embodiment of the invention.

FIG. 23 illustrates toluene vapor sorption at a 200 ppm penetrant concentration (flow rate=50 mL/min, T=25° C.) in 20 nm polymer films formed by a) spin-coating, b) APPI-HLT-FRGP, and c) APPI-NMGP on modified aSi-QCM surfaces (sorption curves are fitted to Fickian diffusion profile).

FIG. 24 illustrates toluene vapor penetrant diffusivity for a range of 50 to 200 ppm penetrant in polymer layers formed by spin-coating, APPI-HLT-FRGP, and APPI-NMGP on aSi-QCM surfaces at both 10 and 20 nm film thickness (flow rate=50 mL/min, T=25° C.).

FIG. 25 illustrates equilibrium sorption of toluene vapor in polymer films formed by spin-coating, APPI-RI-FRGP, and APPI-NMGP on aSi-QCM surfaces for a range of 50 to 200 ppm penetrant concentration (flow rate=50 mL/min, T=25° C.).

FIG. 26 illustrates toluene penetrant mass uptake (t_{ads}) and removal (t_{des}) in sorption-desorption cycle for 20 nm thick spin-coated polystyrene film at 120 ppm toluene concentration (flow rate=50 mL/min, T=25° C.).

FIG. 27 illustrates toluene penetrant mass uptake (t_{ads}) and removal (t_{des}) in sorption-desorption cycle for 20 nm thick polymer films formed by APPI-RI-FRGP at 120 ppm toluene concentration (flow rate=50 mL/min, T=25° C.).

FIG. 28 illustrates toluene penetrant mass uptake (t_{ads}) and removal (t_{des}) in sorption-desorption cycle for 20 nm thick polymer films formed by controlled APPI-NMGP at 120 ppm toluene concentration (flow rate=50 mL/min, T=25° C.).

FIG. 29 illustrates equilibrium sorption of chloroform vapor in polymer films formed by spin-coating, APPI-RI-FRGP, and controlled APPI-NMGP on aSi-QCM substrates for a range of 80 to 310 ppm penetrant concentration (flow rate=50 mL/min, T=25° C.).

FIG. 30 illustrates chloroform vapor penetrant diffusivity for a range of 80 to 310 ppm penetrant in polymer layers formed by spin-coating, APPI-RI-FRGP, and controlled APPI-NMGP on aSi-QCM substrates at 20 nm film thickness (flow rate=50 mL/min, T=25° C.) according to embodiments of the invention.

### DETAILED DESCRIPTION

### Definitions

The following definitions apply to some of the aspects described with respect to some embodiments of the invention. These definitions may likewise be expanded upon herein.

As used herein, the singular terms “a,” “an,” and “the” include plural referents unless the context clearly dictates otherwise. Thus, for example, reference to an object can include multiple objects unless the context clearly dictates otherwise.

As used herein, the terms “optional” and “optionally” mean that the subsequently described event or circumstance may or may not occur and that the description includes instances where the event or circumstance occurs and instances in which it does not.

### Polymer Layers and Methods of Making the Same

Some embodiments of the invention relate to the synthesis of a highly sensitive and selective thin polymeric film sensing layer, prepared by atmospheric pressure plasma-induced graft polymerization, that is composed of a highly dense, covalently and terminally bound, nano-structured polymer layer with unique sorption and diffusion behavior. In some embodiments, the polymer layer has a density or volume of between 12 and 24 nm³/μm². In other embodiments, the polymer has a density or volume of greater than 24 nm³/μm². The grafted brush layer, designed in accordance with embodiments of the invention, has a faster signal response time, higher sensitivity, and increased signal reproducibility, relative to traditional spin-coated polymers or other polymer layer structure with longitudinally arranged polymer chains, due to the structural physical properties of the dense polymer chains which allow for a higher penetrant sorption and diffusivity.

The grafted layer is created by plasma surface treatment and monomer addition polymerization from activated surface sites. The atmospheric pressure plasma source acts as a superior method for creating surface activation sites (without the need for using chemical initiators or other active chemicals for grafting onto the surface) of a controlled surface density from which polymer chains may grow by either free-radical graft polymerization or controlled radical graft polymerization (i.e., reverse/forward atom transfer radical polymerization (ATRGP), nitroxide mediated graft polymerization (NMGP), reversible addition-fragmentation chain transfer graft polymerization (RAFTGP), anionic graft polymerization, or a combination thereof).

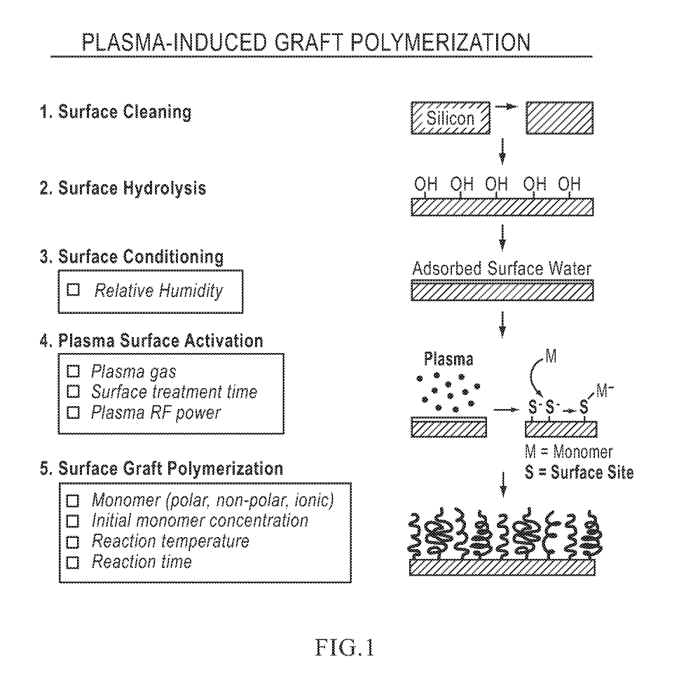

FIG. 1 is a flow chart of a process for plasma-induced graft polymerization according to an embodiment of the invention. The process includes cleaning the surface of the substrate; performing a hydrolysis step on the surface, conditioning the surface, activating the surface via a plasma gas, and polymerizing the surface by contacting the surface with a monomer. An example a plasma-induced graft polymerization process is disclosed in WO 2008/060522 entitled “Atmospheric Pressure Plasma-induced Graft Polymerization,” the disclosure of which is hereby incorporated by reference in its entirety.

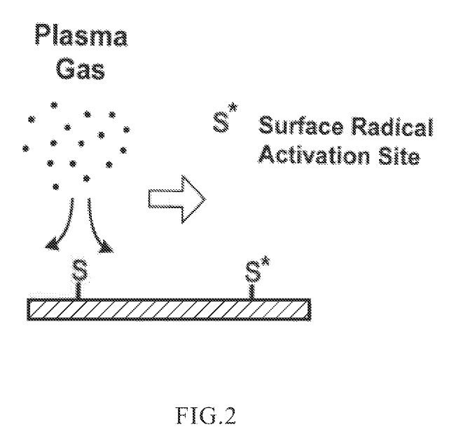

FIG. 2 is a schematic illustration of the surface activation according to one embodiment of the invention. Specifically, the plasma activates locations on the surface of the substrate.

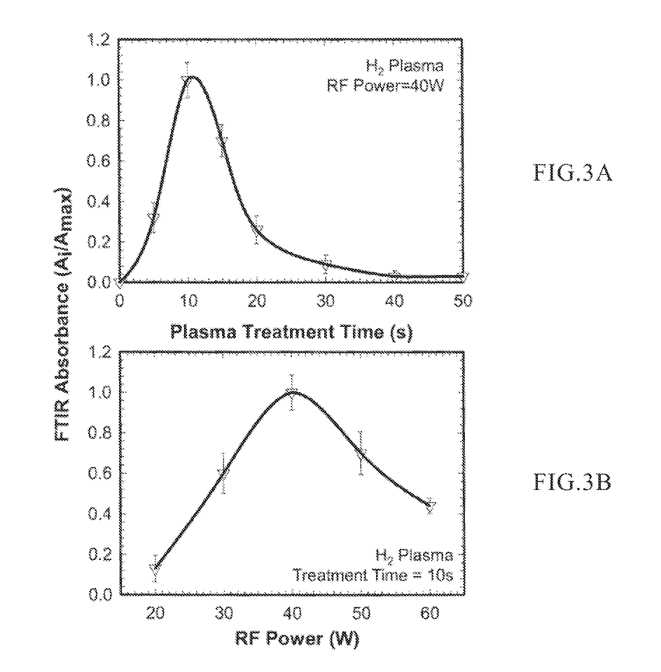

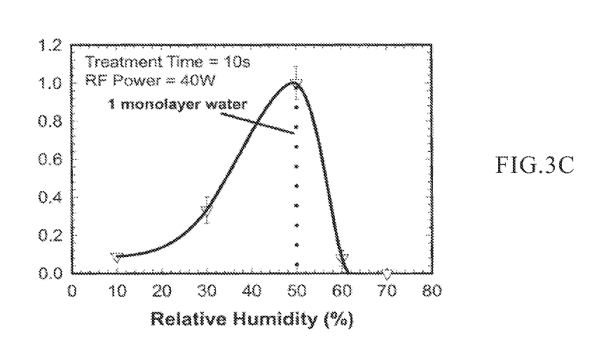

The density of surface activation sites is controlled by adjusting the atmospheric pressure plasma, RF power, surface treatment time, and the surface chemistry can be engineered by using various plasma precursor gases (e.g., hydrogen, oxygen, nitrogen, helium, water, etc.). FIGS. 3A-3C are plots illustrating the variance of the surfaces as the plasma treatment time, RF power, and relative humidity are varied, respectively, during the plasma activation process.

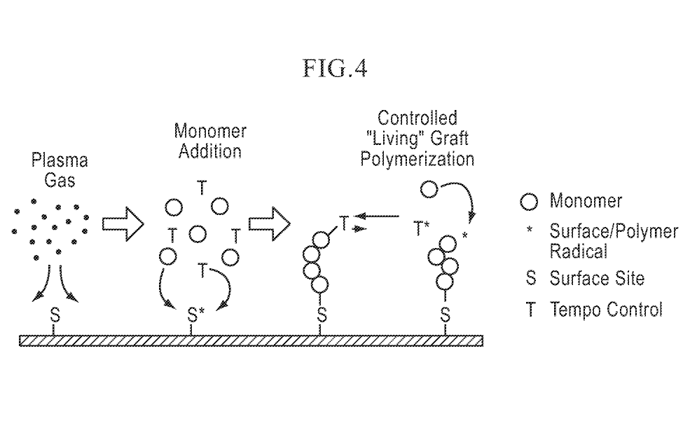

FIG. 4 illustrates a process for controlling the polymerization according to one embodiment of the invention. In this embodiment, after the monomer is added, the graft polymerization is controlled. Specifically, in some embodiments, such a process allows the control of the surface thickness and density.

In one embodiment the surface of the substrate is contacted or treated with a mixture of a monomer solution and 2,2,6,6-tetramethyl-1-piperidinyloxy (TEMPO). The TEMPO is used in the solution to retard polymer chain termination.

The sensing layer properties of the grafted polymer layer may be engineered for hydrophilic, hydrophobic, polar, non-polar, and ionic sensing by choosing appropriate vinyl monomers and by controlling the rate of surface polymerization via initial monomer concentration, reaction temperature, and reaction time. By tuning the surface activation and graft polymerization conditions, a dense polymer brush layer is created so as to change the surface chemistry and topography with the goal of increasing signal response, sensor sensitivity, and signal reproducibility. The sensing layer was shown to have high absorption capacity for organics and reproducible performance. The affixation of the sensing layer onto a quartz crystal microbalance revealed that the sensing layer has higher sorption capacity and faster diffusion than traditional polymeric sensing layers. In some embodiments, the sensing layer used to sorb volatile organics from the gas phase. Moreover, upon repeated cycles of sorption/desorption, the disclosed grafted sensing layers did not show any hysteresis which is a major advantage over existing sensors. Nano-structured sensing layers may be created on a range of transducers such as mass, conductive, optic, acoustic, pressure, spectroscopic, and mechanical transducers.

Some embodiments of the invention can be used for nanostructuring of thin films by atmospheric pressure plasma-induced graft polymerization from any organic, polymeric, and inorganic surface that allows for the formation of surface peroxides, epoxides, or other initiation sites by plasma surface treatment. The plasma source may be used either as a fixed source with a moveable substrate for surface treatment or the plasma source may be a moveable source with a fixed substrate.

As further described herein, the disclosed process has been designed, the plasma initiated grafting efficiency has been measured, optimal conditions have been determined, and process runs with a modified surface have been conducted to study the sensing layer properties (i.e., signal response time, solute sensitivity, and reproducibility).

Some embodiments of the invention can impart permanent (or substantially permanent) physical and chemical properties to substrate materials with graft polymerization. For example, in one embodiment, for surface nano-structuring of polymer sensing layers, a plasma treatment using a series of planar (slit type) atmospheric plasma jet is used.

### Example

### Controlled Nitroxide-Mediated Styrene Surface Graft Polymerization with Atmospheric Plasma Surface Activation

Surface modification of inorganic and organic materials with chemically end-grafted brush polymers combine the thermal and mechanical properties of the support material with a highly stable, functionalized polymer phase that can be tailored with unique chemical and physical properties. Graft polymerized polystyrene offers unique properties in applications such as micropatterning in electronics fabrication, adhesion in carbon fibers and rubber dispersions, and as selective layers in fuel cells and separation membranes. Structuring surfaces with grafted polystyrene is commonly achieved by free radical graft polymerization (FRGP), where the polymer chain size, chain length uniformity, and surface density are dictated by the initial monomer concentration, reaction temperature and density of the surface immobilized initiators or initiators in solution. However, broad molecular weight chain size distributions resulting from uncontrolled macroradical reactions in solution and limitations of achievable surface initiation site density make the traditional FRGP approach unattractive for nanoscale-engineered polymer surface architectures.

Plasma-induced graft polymerization resolves the above limitations via surface activation by plasma treatment to create a dense coverage of surface activated sites, from which liquid phase vinyl monomer addition may proceed to form grafted polymer chains. Polystyrene surface grafting can be achieved by low pressure plasma-induced graft polymerization for surface structuring of Nafion fuel cells, poly(vinylidene fluoride) pervaporation membranes and polyethylene powders as well as titanium dioxide particles. However, low-pressure plasma-induced graft polymerization involves the use of vacuum chambers, which limits the practical scale-up potential for industrial applications. A suitable alternative, atmospheric pressure (AP) plasma-induced graft polymerization using corona discharge or dielectric barrier discharge plasma sourced for surface activation of polymeric substrates such as poly(ethylene terephthalate) and polystyrene, has received limited attention, primarily due to the plasma source limitations (i.e., fixed plate geometry, plasma gas choice, and operating range). A remote AP hydrogen plasma jet can be used to activate inorganic substrates and create dense layers of grafted poly(vinylpyrrolidone) from silicon surfaces by plasma-induced graft polymerization. The surface number density of AP plasma activated surface sites was dependent on the adsorbed surface water coverage, which assisted in plasma surface activation, and the plasma operating parameters (i.e., surface treatment time and radio frequency power). The resulting polymer grafted silicon substrates were characterized by a high surface density of grafted polymer chains with a maximum polymer feature size (i.e., layer thickness) of 50-80 Å and chain spacing (i.e., surface density) of 10-50 Å, both of which scaled with initial monomer concentration.

The demand for advanced materials for nanoscale devices has recently led to a growing interest in surface modification via controlled radical polymerization (CRP), whereby grafted polymer domains may be structured by controlled polymer chain growth and grafted chain polydispersity. CRP utilizes a chemical agent which reversibly binds to the surface-bound macroradical chain, establishing a thermodynamic equilibrium that favors the capped polymer in the dormant phase. The presence of the chemical agent limits the number of “living” chains in solution, thus enabling control over the rate of surface polymerization while reducing chain termination. Controlled polystyrene graft polymerization, with number-average molecular weights (Me) and polydispersity indices (PDI), can be carried out for the following CRP methods: atom transfer radical graft polymerization (ATRGP) (Mₙ=10,400-18,000 g/mol and PDI=1.05-1.23), reversible addition-fragmentation chain transfer (RAFT) graft polymerization (Mₙ=12,800-20,000 g/mol, PDI=1.10-1.40), and nitroxide-mediated raft polymerization (NMGP) (Mₙ=20,000-32,000 g/mol, PDI=1.20-1.30) for grafting of polystyrene onto silica and polymeric materials (e.g., polyglycidyl methacrylate (PGMA), polythiophene, polypropylene, and polyacrylate). However, it should be noted that ATRGP and RAFT graft polymerization pose unique challenges. For example, ATRGP involves a specific and precise initiator to catalyst to monomer ratio, optimal temperature/solvent conditions, and surface-bound organic halide initiators. Similarly, surface-bound initiators (e.g., thio-ester) are used to achieve RAFT graft polymerization. NMGP, on the other hand, relies on conventional peroxide initiators and/or thermal initiation to form polymer chain radicals that may then reversibly bind to an alkoxyamine chemical agent for controlled radical polymerization. In one embodiment, the focus was to combine NMGP with AP plasma surface activation to enable the formation of a uniform and highly dense grafted polymer phase with controlled chain growth to yield grafted polymers of a narrow molecular weight distribution.

The integration of atmospheric pressure (AP) hydrogen plasma surface activation with controlled NMGP was evaluated for the synthesis of nano-structured polystyrene-silicon surfaces. The growth of the grafted polymer layer was analyzed, based on reaction schemes, to demonstrate the capability for controlled surface graft polymerization. Surface topography was characterized by atomic force microscopy (AFM) to evaluate the polymer feature height distribution and uniformity of grafted polymer surface coverage.

Prime-grade silicon <100> wafers used in this study were obtained from Wafernet, Inc. (San Jose, Calif.). Native wafer samples were single-side polished and cut to 1 cm square pieces for processing. De-ionized (DI) water was produced using a Millipore (Bedford, Mass.) Milli-Q filtration system. Hydrofluoric acid, sulfuric acid, and aqueous hydrogen peroxide (30 vol %) were obtained from Fisher Scientific (Tustin, Calif.). Chlorobenzene (99%) and tetrahydrofuran (99.99%) were obtained from Fisher Scientific (Tustin, Calif.). Styrene (99%) with catechol inhibitor (<0.1%), obtained from Sigma Aldrich (St. Louis, Mo.), was purified by column chromatography using a silica column (Fisher Scientific, Tustin, Calif.). 2,2,6,6 Tetramethyl-1-piperidinyloxy radical (TEMPO, 98%), used as a control agent for controlled nitroxide-mediated graft polymerization, was obtained from Sigma Aldrich (St. Louis, Mo.) and was used as received.

Silicon wafers were cleaned (to remove adsorbed organics and the native oxide layer) by a sequential acid-etching process. Briefly, the silicon substrates were cleaned in a piranha solution (70% sulfuric acid, 30% hydrogen peroxide) for 10 min at 90° C. and then triple rinsed to remove residuals (caution: this solution reacts violently with many organic materials and should be handled with extreme care). Substrates were then dipped in a 50 vol % aqueous solution of hydrofluoric acid to remove the native oxide layer and then triple rinsed and vacuum dried at 100° C. It was previously shown that the surface density of polymer anchoring sites could be maximized by optimal control of adsorbed surface water. Accordingly, dried silicon substrates were subsequently placed in a humidity chamber for 12 h to allow for controlled surface water adsorption. The insulated chamber was maintained at a temperature of 22° C. and was humidified with DI water at 50% relative humidity (% RH).

Silicon substrates were plasma treated under an inert nitrogen atmosphere to minimize exposure to atmospheric oxygen, which can react with, and destroy, surface free radicals. The atmospheric pressure (AP) plasma source used in the present study was a cylindrical plasma jet. The plasma jet was positioned about 1 cm above the substrate surface and was operated at 100-250 V with a radio frequency power (RF) of 13.56 MHz. A mixture of 1 vol % ultra-high purity hydrogen (99.999%) in helium (99.999%) was delivered to the AP plasma source at a total flow rate of about 30 L/min. Silicon substrates were plasma treated for a period of 10 s at an RF power of 40 W and then were briefly immersed in DI water. For FRGP, the hydrogen plasma treated silicon substrates were graft polymerized in a 0.87 to 4.36 M (10 to 50 vol %) styrene-chlorobenzene mixture at T=70° C., 85° C., and 100° C. For NMGP, the hydrogen plasma treated silicon substrates were graft polymerized in a 4.36 M (50 vol %) styrene chlorobenzene mixture at a temperature range of 100 to 130° C. and TEMPO molar concentration range of 5 to 15 mM. Following the polymerization reaction, the polymer modified silicon substrates, for both FRGP and NMGP, were sonicated for 2 h in toluene at room temperature to remove surface adsorbed homopolymers, rinsed in tetrahydrofluran, and vacuum dried at 100° C.

Surface modification of the silicon surfaces was confirmed by Attenuated Total Reflectance Fourier Transform Infrared (ATR-FTIR) spectroscopy using a BioRad FTS-40 FTIR equipped with an Attenuated Total Reflectance accessory (BioRad Digilab Division, Cambridge, Mass.). ATR-FTIR spectra for polystyrene-grafted substrates was post processed, and all spectra were reported in terms of Kubelka-Munk absorbance units.

The grafted polystyrene layer thickness was determined using a Sopra GES5 Spectroscopic Ellipsometer (SE) (Westford, Mass.). The broadband variable angle SE was operated over the range of 250-850 nm and the data were analyzed using multi-layer polymer film models that were fitted using the non-linear Levenberg-Marquardt regression algorithm to extract the polystyrene layer thickness. Each reported measurement was averaged over five locations on the substrate and the resulting standard deviation for all the surfaces did not exceed 10% of the measured layer thickness.

Contact angle measurements for the polystyrene-grafted silicon substrates were determined by the sessile-drop method with a Kruss Model G-23 contact angle instrument (Hamburg, Germany). Measurements were made using DI water at 22° C. and about 30% R.H. Each reported contact angle datum was obtained by averaging the results from 5 separate drops on different areas of the given substrate. The size and volume of the drops were kept approximately constant to reduce variations in contact angle measurements. Before the measurements, each substrate was rinsed and sonicated separately in tetrahydrofuran and then water, each for 15 min, followed by vacuum drying for 30 min at 80° C.

Atomic force microscopy (AFM) surface analysis was used to measure the surface feature height distribution (i.e., the Z-height of the polymer features from the surface), surface roughness, feature diameter, and surface coverage of the polystyrene modified surfaces. AFM analysis was performed using a Multimode AFM with a Nanoscope IIIa SPM controller (Digital Instruments, Santa Barbara). All AFM scans were taken in tapping mode in ambient air using NSC15 silicon nitride probes (Digital Instruments, Veeco Metrology Group, Santa Barbara, Calif.) with a force constant between 20-70 N/m, a nominal radius of curvature of 5-10 nm and a side angle of 20°. AFM scans of 1×1 μm² silicon substrates were taken at a scan rate of 0.5-1.0 Hz. At least five locations were sampled for each modified substrate, with two scans taken for each location. Surfaces were imaged at 0 and 90° to verify that images were free of directional distortions.

The root-mean-square (RMS) surface roughness, Rᵣₘₛ, was calculated from the height data and determined from

$${R}_{RMS} = \sqrt{\frac{\sum {( {Z}_{i} - {Z}_{avg} )}^{2}}{N}} \qquad ( 1 )$$

where Zᵢ is the ith height sample out of N total samples, and Z_{avg} is the mean height. The skewness, S_{skew}, which is a measure of the asymmetry of the height distribution data about the mean, was determined from

$${S}_{skew} = \frac{\sum {( {Z}_{i} - {Z}_{avg} )}^{3}}{( N - 1 ) \cdot {σ}^{3}} \qquad ( 2 )$$

where σ is the standard deviation. In order to provide a measure of the grafted polymer feature height distribution relative to the native substrate, the average Z-height of the native silicon surface (0.3-0.5 nm), determined from five locations for each surface, was subtracted from the surface feature height data for the polymer modified substrate. The adjusted Z-height data were then fitted to a Gaussian distribution to clarify the presence of tails (small or large features) in the distribution.

The characteristics of the graft polymerized layer were affected by the reaction conditions, which could in turn be adjusted to synthesize the desired properties of the grafted polymer layer. Therefore, it is important to relate the observed surface layer properties (e.g., topography, surface uniformity, and surface feature density) to the reaction mechanism responsible for the polymer layer formation. Although surface grafting kinetics is not the focus of the present study, it is instructive to qualitatively explore the potential reaction mechanism responsible for the formation of the present graft polymerized polystyrene layers. Accordingly, a general reaction scheme for atmospheric pressure plasma-induced free radical graft polymerization (APPI-FRGP) and nitroxide-mediated graft polymerization (APPI-NMGP) of polystyrene is illustrated in Table 1. The proposed reaction scheme considers two initiation mechanisms: 1) AP hydrogen plasma surface activation followed by surface initiation (eqs 3a-f) and 2) thermal solution initiation (eqs 4a-d) of styrene monomer, which for styrene polymerization is significant at reaction temperatures of approximately T≧100° C. Plasma surface activation is achieved by the dissociation of molecular hydrogen in gas phase collisions to form hydrogen plasma (eq 3a) which may react with surface sites and adsorbed surface water (eq 3c) to form surface activated sites (SI). The plasma-activated surface sites have been previously characterized as surface peroxides by FTIR spectroscopy and a surface radical binding assay. Activated sites may be destroyed when the surface is sufficiently oversaturated by plasma species (eq 3d).

Precise control of the plasma treatment time and RF power limits surface passivation and allows for a highly dense surface coverage of radical initiators (eq 3e), from which vinyl monomers may combine to form surface grafted polymer chains (Sₙ •) (eq 3f, where S designates a surface anchoring site and n is the number of monomers in the surface anchored chain). At elevated temperatures, thermal solution initiation may occur, whereby monomer decomposition leads to the formation of a Diels-Alder adduct (AH) from styrene (eq 4a), followed by molecular homolysis of AH and styrene (eq 4b), to form radical initiators in solution (eqs 4c-d) which may combine with surface growing chains (eq 7e, f) and initiate the growth of polymer chains in solution. Once polymer chain growth (in solution or on the surface) is initiated, the chains continue to grow by monomer propagation (eqs 5a, c) with chain growth impacted by chain transfer (eqs 6a, b) and chain termination (eqs 7a-f). Controlled polymer growth at the surface and in solution by NMGP may be attained by reversible coupling with TEMPO (T, eqs 5b, d) to yield polymers with narrower size distributions than possible by FRGP.

TABLE 1
Table 1 includes equations 3-7 (proposed reaction schemes for
plasma-induced controlled nitroxide-mediated graft polymerization).

| | (Eq) |
|---|---|
| Plasma Activation & Surface | |
| Initiation | |
| 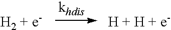 | (3a) |
| 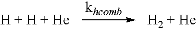 | (3b) |
| 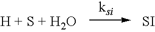 | (3c) |
| 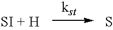 | (3d) |
| 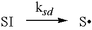 | (3e) |
| 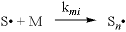 | (3f) |
| Thermal Solution Initiation | |
| 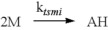 | (4a) |
| 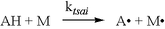 | (4b) |
| 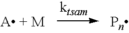 | (4c) |
| 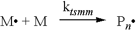 | (4d) |
| Propagation | |
| 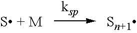 | (5a) |
| 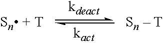 | (5b) |
| 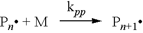 | (5c) |
| 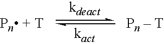 | (5d) |
| Chain Transfer | |
| 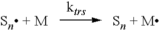 | (6a) |
| 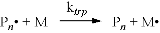 | (6b) |
| Termination | |
| 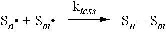 | (7a) |
| 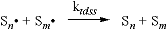 | (7b) |
| 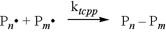 | (7c) |
| 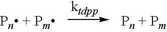 | (7d) |
| 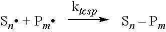 | (7e) |
| 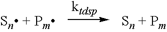 | (7f) |

Surface graft polymerization by monomer addition from plasma-activated surface sites would be expected to prevail when thermal initiation of monomer in solution does not occur or is at a sufficiently slow rate of initiation—a condition that would be expected below about 100° C. At higher reaction temperatures (i.e., T≧100° C.), thermal monomer initiation in solution may be significant, leading to the formation of bulk phase macroradicals that may react with active surface sites (eqs 7e and 7f). Accordingly, styrene graft polymerization was evaluated in the present study for the above two graft polymerization regimes: (a) Regime 1, for which surface chain growth is dominated by monomer addition (at 70° C. and 85° C.), and (b) Regime II, for which thermal initiation in solution may occur, leading to the formation of macroradicals in solution, and thus enabling the grafting of bulk polymer chains onto the surface and affecting the growth and limiting the surface density of the graft polymer layer (at 100° C.).

The rate of monomer addition to surface chains by FRGP (R¹ₛₚ) in Regime I (i.e., “grafting from,” with limited thermal solution initiation) can be approximated, by using PSSH, to be the following:

$${R}_{sp}^{I} = {k}_{sp} [ {S}_{n} \cdot ] [ M ] = {{{k}_{sp} [ \frac{{f}_{d} {k}_{sd}}{{k}_{ts}} ]}^{1 / 2} [ SI ]}^{1 / 2} [ M ] \qquad ( 8 )$$

where kₛₚ, k_{sd} and kₜₛ are the rate coefficients for surface-bound chain propagation, initiator decomposition and polymer chain termination at the surface (i.e., by combination and disproportionation, kₜₛ=k_{tcss}+k_{tdss}), respectively; [Sₙ •] and [M] are the concentrations of surface-bound polymer radicals and monomer in solution, respectively; and [SI] is the concentration of activated surface species which decompose by thermally enhanced, first-order decomposition kinetics (i.e., [SI]=[S1]₀^{-fk}^{_{sd}}^{t}). Thermal first-order decomposition of surface peroxides has been previously demonstrated for surface activation by gamma irradiation and UV irradiation.

The rate of monomer consumption (or polymerization) in Regime II, Rₘ^{II}, can be approximated as the sum of the rate of surface graft polymerization, Rₛₚ^{I}, and the rate of polymerization in solution due to thermal initiation, R^{T}ₚₚ, (i.e. Rₘ^{II}=R^{I}ₛₚ+R^{T}ₚₚ=kₛₚ[Sₙ•∥M]+kₚₚ[Pₙ•∥M]), if one assumes that the fraction of monomer consumed in the chain transfer and termination reactions is negligible compared to monomer addition. The concentration of macroradical chains formed in solution ([Pₙ •]) by thermal solution initiation may be derived from the Mayo mechanism and is expressed as the following:

$$[ {P}_{n} \cdot ] = {( \frac{( {k}_{tsam} + {k}_{tsmm} ) [ M \cdot ] [ M ]}{2 ( {k}_{tcpp} + {k}_{tdpp} )} )}^{1 / 2} \qquad ( 9 )$$

where kₜₛₐₘ and ktₛₘₘ are the rate constants for thermal solution initiation by the Diels-Alder adduct and monomer decomposition; k_{tcpp} and k_{tdpp} are the rate constants for chain combination and disproportionation in solution; and [M •] is the concentration of monomer radicals in solution ([M •])=2kₜₛₐᵢ [M]/(kₜₛₐₘ+kₜₛₘₘ)), where kₜₛₐᵢ is the rate constant for initiation by the Diels-Alder adduct. It should be noted, however, that the rate of polymer film growth in Regime II (Rₛₚ^{II}) is the combination of the rate of surface graft polymerization (Rₛₚ^{I}) and the rate of polymer grafting of chains, thermally initiated in solution, to surface growing chains (Sₙ•) and surface activated sites (S •), given by the following expression: Rₛₚ^{II}=Rₛₚ^{I}+k′[Pₙ •]([Sₙ •]+[S •]), where k′ is the rate constant for polymer grafting. Then, as the rate of thermal solution initiation increases with reaction temperature, the formation of macroradical chains leads to increased polymer grafting (i.e., “grafting to”) of Pₙ • chains to the surface (eq 7e).

Nitroxide-mediated graft polymerization (NMGP) from plasma activated surface sites is achieved when a control agent (i.e., TEMPO) reversibly binds to growing (or “living”) surface-bound polymer chains. Due to the fast exchange of the TEMPO radicals with the polymer chains, a quasi-equilibrium is established and the concentration of dormant and growing chains at the surface and in solution can be expressed as follows:

k_{deact}[Sₙ•]*[T]*=k_{act}[Sₙ−T]* (10)

k_{deact}[Pₙ•]*[T]*=k_{act}[Pₙ−T]* (11)

where k_{deact} and k_{act}, are the deactivation and activation rate constants for the controlled polymerization reaction; [T], [Sₙ−T] and [Pₙ−T] are the concentrations of TEMPO and TEMPO-bound polymers at the surface and in solution, respectively; and the superscript denotes species that are present in solution at steady-state concentrations. The concentration of chains growing from the surface ([Sₙ •]) may be written, from eq 10, in the following form

$$[ {S}_{n} \cdot ] = \frac{{k}_{act}}{{k}_{deact}} \frac{{[ {S}_{n} - T ]}^{*}}{{[ T ]}^{*}} = K \frac{{[ {S}_{n} - T ]}^{*}}{{[ T ]}^{*}} \qquad ( 12 )$$

where K is the activation-deactivation equilibrium constant. The rate of nitroxide-mediated surface polymerization is obtained by the combination of eq 8 and eq 12 to give the following expression:

Rₛₚ=Kₐₚₚ[M] (13)

where Kₐₚₚ=kₛₚK[Sₙ−T]*/[T]*is the apparent equilibrium rate coefficient.

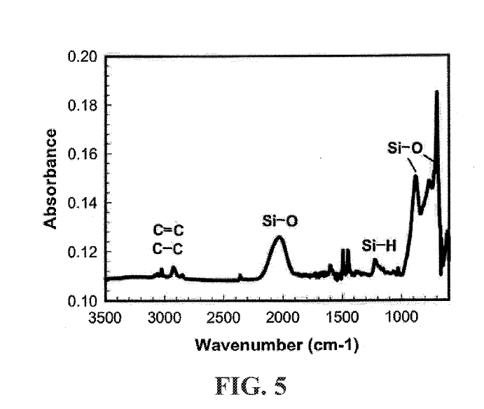

Polystyrene was chemically grafted to silicon using a two-step plasma-induced graft polymerization approach combining surface activation by atmospheric pressure (AP) plasma surface treatment with styrene graft polymerization by monomer addition to activated surface sites. Consistent with previous work, the surface density of grafted polymer sites was dependent on the plasma processing parameters (i.e., surface conditioning, plasma treatment time, and RF power). The reaction conditions, specifically the initial monomer concentration and temperature, determined the surface-bound polymer chain properties (i.e., polymer layer thickness), which may be concluded from the established reaction mechanism for FRGP. EDS (energy dispersive spectroscopy) analysis of the polystyrene modified surface confirmed the presence of carbon atoms at the substrate, corresponding to the polystyrene backbone and functional groups. ATR-FTIR surface analysis (FIG. 5) of the modified silicon substrate revealed Si—O bond bending and stretching (between 1900-2200 cm⁻¹ and 700-1000 cm⁻¹) as a result of plasma surface treatment and Si—H bond stretching (near 1200 cm⁻¹) corresponding to the native silicon. Grafted polystyrene was identified in the IR spectrum with peaks identifying the alkene C—C and alkene C═C bond stretching (at 3000 cm⁻¹) corresponding to the benzene functional groups.

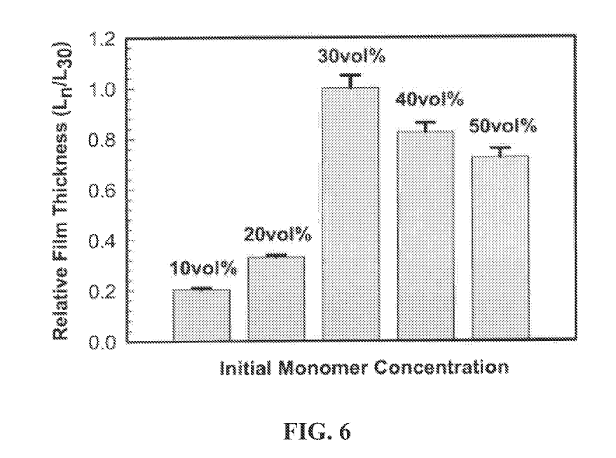

In order to determine the most suitable plasma-induced FRGP reaction conditions to maximize the polystyrene film thickness, a series of experiments were conducted for a styrene initial monomer concentration range of 0.87 to 4.36 M (10 to 50 vol %) at 85° C. (FIG. 6), with the reaction allowed to proceed up to 8 h. An increase in polymer layer thickness with monomer concentration was observed from [M]₀=0.87 to 2.62 M, with a maximum polystyrene film thickness of 75 Å at [M]₀=2.62 M. The grafted polymer layer thickness formed at [M]₀=2.62 M was about a factor of five higher than at [M]₀=0.87 M (15 Å). However, upon increasing the initial monomer concentration to [M]₀=4.36 M, only a 55 Å grafted polystyrene layer thickness could be achieved, a decrease of more than 25% relative to [M]₀=2.62 M. The increase in grafted polymer layer thickness with initial monomer concentration ([M]₀=0.87 to 2.62 M) was expected, as implied by the FRGP kinetic equation for the rate of monomer addition to surface chains (eq 8). For the range of low initial monomer concentrations, the polymer layer thickness increased with monomer suggesting that the rate of monomer addition dominated surface graft polymerization. The existence of a maximum layer thickness was not surprising, however, given the expected competition between graft polymerization (eq 5a) and chain termination (eq 7a-f). It is hypothesized that above a critical initial monomer concentration, the rate of polymer grafting (eq 7e, f) from macroradicals, formed by surface-initiator fragmentation and monomer addition in solution, and surface-bound chain termination (eq 7a, b) led to a reduction in the number of surface anchored macroradicals that could continue to grow by monomer propagation. As a result, chain growth diminished, noted by a reduction in grafted polymer layer thickness.

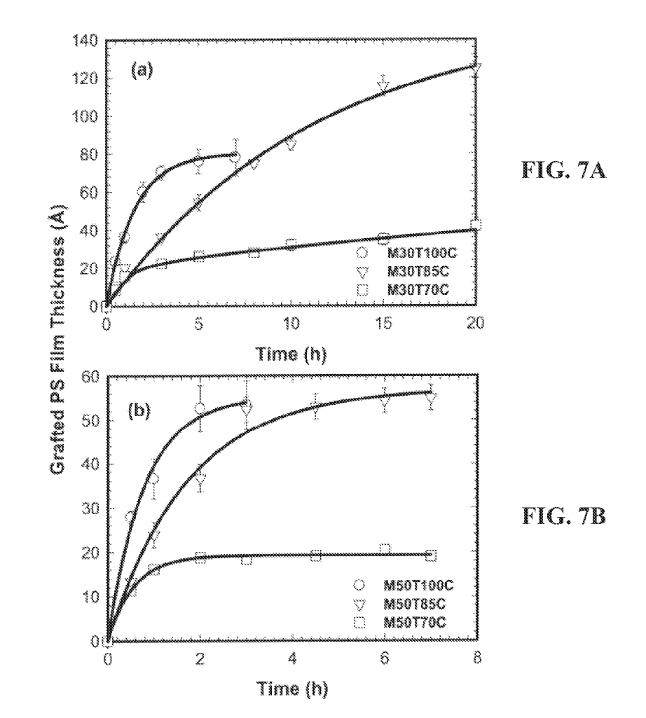

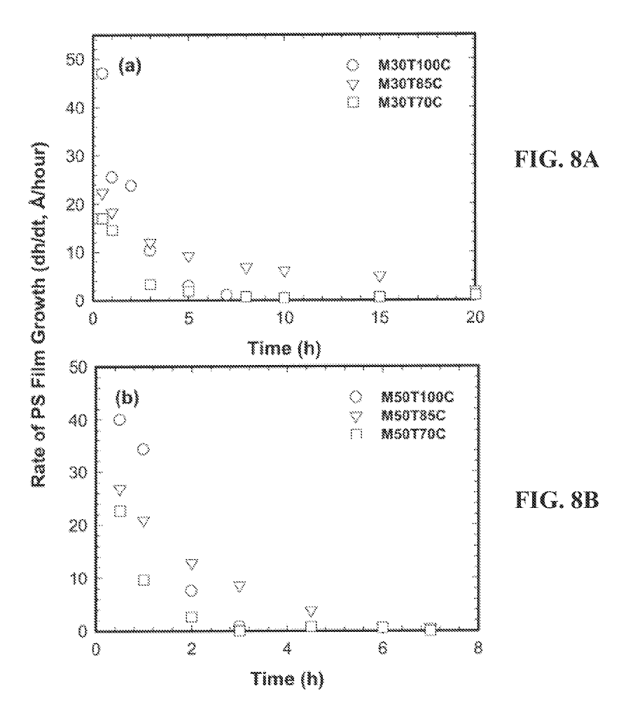

Polystyrene film growth in Regime I (APPI-FRGP at 70 and 85° C.) and Regime II (APPI FRGP with thermal solution initiation at 100° C.), at the previously noted optimal reaction condition of [M]₀=2.62 M (30 vol %), exhibited strikingly different growth behavior, with a high initial growth rate observed in Regime II and a lower growth rate but a somewhat more linear polymer growth observed in Regime I (FIG. 7A). The polymer layer growth at 100° C. was characterized by an initial growth rate of 45 Å/h at 30 min (FIG. 8A) that appeared to approach a plateau with respect to time, reaching a polymer film thickness of about 80 Å after 7 h (FIG. 7A). In contrast, polymer layer growth at 70° C. and 85° C. exhibited a lower initial growth rate with respect to time, resulting in polymer growth rate of about 22 Å/h at 30 min for both reaction temperatures (FIG. 8A) and a polymer film thickness of 125 Å and 42 Å after 20 h at 85° C. and 70° C., respectively (FIG. 7A). The increase in the initial rate of polymer film growth from Regime I to Regime II was expected, given the increase in kₛₚ with temperature, which has been shown to follow an Arrhenius dependence. However, the observed decline in polymer growth after about 5 h in Regime II may be due to polymer grafting of macroradical polymers, formed in solution by thermal initiation, to growing surface chains and thus terminating further surface chain growth (eq 7e, f). The effect of polymer grafting at 100° C. on the polymer film growth was noted by a 36% decrease in polystyrene film thickness, relative to graft polymerization at 85° C. APPI FRGP at 70° C. and 85° C., on the other hand, appeared to exhibit a lesser deviation from linear growth behavior, presumably due to reduced thermal solution initiation and polymer grafting, and allowed for reasonable growth (via monomer addition) from surface chains. The evolution of polymer growth and polymer surface coverage was also observed by an increase in water contact angle (i.e., decreased surface wetting) with reaction time from 70° C. to 100° C. at [M]₀=2.62 M (Table 2). The water contact angle (CAW) increased as the polymer layer thickness increased from Regime I to Regime II at [M]₀=2.62 M. For example, for APPI-FRGP at 70° C., a 46% increase in the contact angle (CA_{w}=57.9°) corresponded to an increase in grafted polystyrene film thickness from 8 to 32 Å after 10 h, relative to the plasma treated silicon surface (CA_{w}=39.5°). Also, graft polymerization at 100° C. for 5 h resulted in a polystyrene film thickness of about 80 Å and a contact angle of 90°, which agreed well with previous studies which reported a water contact angle in the range of 90 to 94° for polystyrene films on mica and silica. It was interesting to note, however, that while graft polymerization at 100° C. (after 5 h), compared to 85° C. (after 10 h), resulted in a similar polymer film thickness, the water contact angle at 100° C. was about 22% greater than at 85° C. This increase in contact angle may be a result of the expected increase in the rate of surface initiation, and, therefore, surface coverage of grafted polystyrene, at higher reaction temperatures.

Table 2 is the water contact angle measurements of polystyrene films grafted to silicon by APPI-FRGP.

TABLE 2

| | Water Contact Angle (°) | | | | |
|---|---|---|---|---|---|
| | Graft Polymerization | | | | |
| Temperature | Reaction Time | | | | |
| (° C.)^{(a)} | 1 hr | 3 hr | 5 hr | 8 hr | 10 hr |
| 70° C. | 49.3 | 51.1 | 55.7 | 56.2 | 57.9 |
| 85° C. | 53.7 | 59.0 | 69.5 | 71.6 | 73.3 |
| 100° C. | 75.7 | 85.5 | 90.0 | 90.0 | — |
| Rapid initiation^{(b)} | 76.3 | 80.5 | 83.0 | 90.0 | 90.0 |

(—) Contact angle not measured.
^{(a)}Substrates grafted at initial monomer concentration of [M]ₒ = 2.62 M
^{(b)}Rapid initiation grafting conditions: Step 1 period of 15 min at T = 100° C. and graft polymerization at T = 85° C. for the remaining reaction period.

An increase in the initial rate of polystyrene film growth was observed when the initial monomer concentration was increased from 2.62 M (30 vol %) to 4.36 M (50 vol %) for reaction conditions at 70, 85 and 100° C. (FIG. 7B). Over the first 30 min, the film growth rate at [M]₀=4.36 M, compared to [M]₀=2.62 M, increased by more than 10% and 20% at 70 and 85° C., respectively (FIG. 8B). However, it was noted that the polymer layer growth approached a plateau within a shorter reaction time at the higher initial monomer concentration. The increase in the rate of polymer layer growth may be the result of a higher concentration of monomer at the surface, and, therefore, an increased rate of monomer addition to surface activated sites. Formation of a higher density of surface-bound polymer chains may lead to diminished polymer layer growth due to an increase in surface-bound polymer-polymer chain combination (eq 7a, b), polymer grafting of chains formed in solution by thermal initiation (eq 4a-d) or from initiator fragments from the surface, or chain transfer (eq 6a). Although the polystyrene film growth rate was enhanced by increasing both the initial monomer concentration and reaction temperature, the achievable film thickness and control of monomer addition to activated surface sites were reduced.

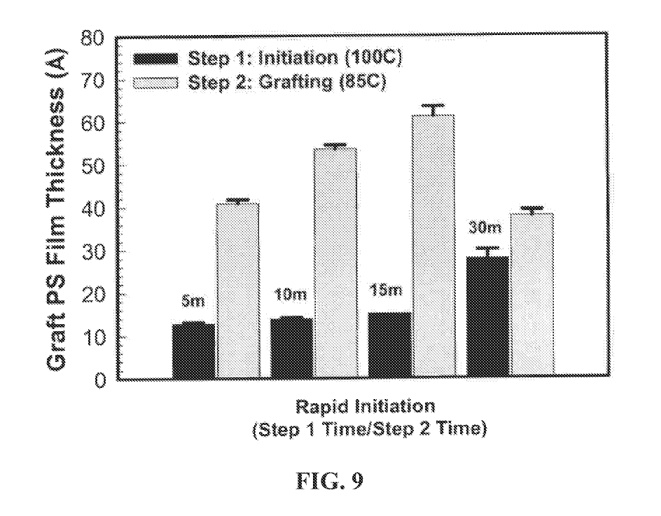

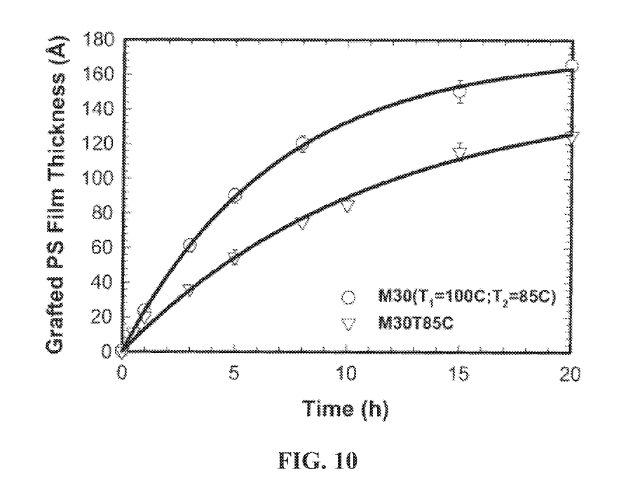

The polystyrene layer growth rate and film thickness were further improved by utilizing an approach in which a high initial rate of polymerization was enabled at a high temperature for a short period, followed by graft polymerization at both a lower temperature and at a relatively low initial monomer concentration, to reduce the potential for polymer grafting. This High-Low Temperature (HLT) free radical graft polymerization sequence, with atmospheric plasma surface activation, was evaluated for an initial monomer concentration of [M]₀=2.62 M with a short high temperature initiation step (Step 1, 100° C.), followed by a low temperature graft polymerization step (Step 2, 85° C.). As shown in FIG. 9, the resulting polymer layer thickness was critically dependent on the length of the initiation step (Step 1). As the graft polymerization initiation period was increased from 5 to 15 min, the polymer layer thickness increased by more than 40% from 40 Å to 62 Å, respectively, after a Step 2 interval of 3 h. Given the increase in polymer layer thickness achieved with the Step 1 period, it is likely that the increase in polymer layer growth was due to the higher initial rate of polymerization achieved in Step 1. A maximum in the layer thickness achieved by the HLT graft polymerization sequence was observed at 15 min, and a 30% decrease in polymer layer thickness was noted when the Step 1 period was increased to 30 min. It is plausible that for long initiation periods (i.e., Step 1>15 min), high reaction temperatures enable the formation of macroradicals by thermal solution initiation, which may diminish polymer layer growth as the result of polymer grafting, as discussed earlier in the Regime II graft polymerization studies. In contrast, HLT graft polymerization more closely resembled the behavior of Regime I graft polymerization at [M]₀=2.62 M and 85° C., as observed in the similar growth behavior for a 15 min Step 1 period (FIG. 10). The polymer layer thickness achieved in the HLT graft polymerization sequence (165 A after 20 h), however, was about 32% higher than without HLT graft polymerization at 85° C. Also, as the reaction proceeded, water contact angle measurements for the polymer layer prepared by the HLT graft polymerization sequence reached a plateau at 90.0° after an 8 h reaction time, compared to 71.6° at 85° C., suggesting a denser coverage of grafted polymer chains that may be achieved by rapid initiation.

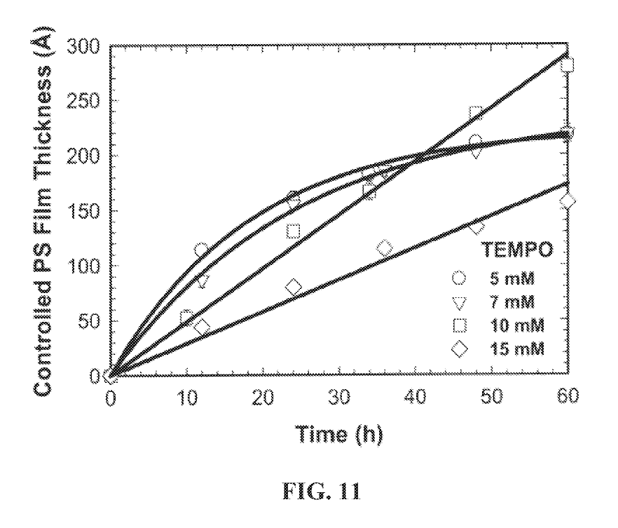

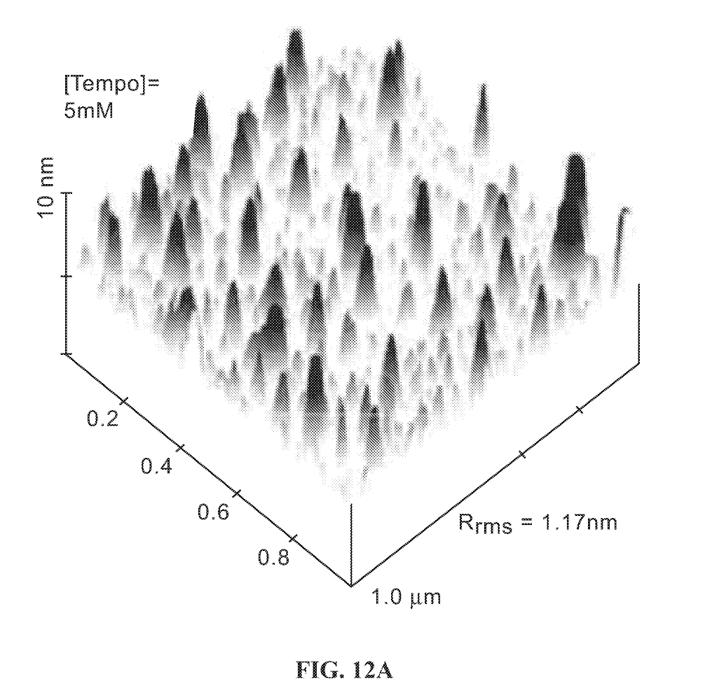

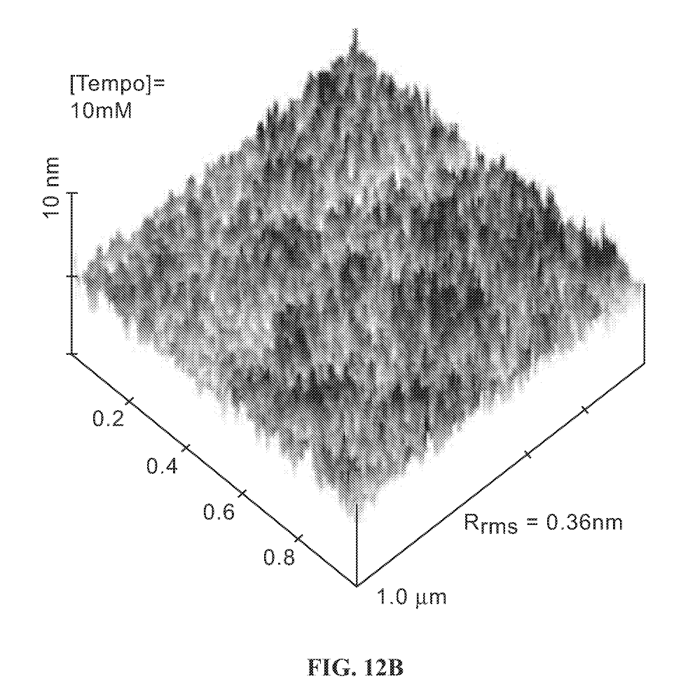

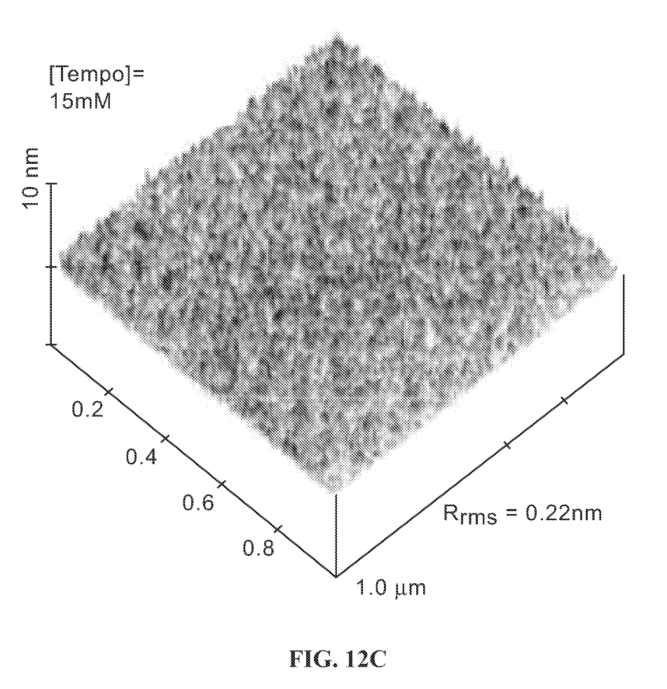

Enhanced control of polystyrene film growth, relative to APPI-FRGP and HLT graft polymerization, was demonstrated by APPI-NMGP, which resulted in linear polymer layer growth with respect to time at [TEMPO]=10 mM, [M]₀=4.36 M, and T=120° C. (FIG. 11). FIG. 12A-12C are AFM images illustrating surface features according to one embodiment of the invention. The linearity of the polystyrene film growth, with respect to time, increased with addition of the TEMPO control agent. Polymer layer growth for [TEMPO]=5 and 7 mM was characterized by a deviation from linear film growth and resulted in a layer thickness of about 220 Å for a reaction period of 60 h. Controlled polymer growth, on the other hand, achieved for [TEMPO]=10 mM, was characterized by linear film growth and resulted in a layer thickness of about 285 Å, achieved for a reaction time of 60 h. For a TEMPO molar concentration less than 10 mM, the observed polymer layer growth was similar to that achieved for FRGP. Such growth behavior would be expected when the concentration of polymer chains is much greater than that of TEMPO, thereby achieving only partially controlled solution polymerization, the occurrence of polymer grafting, and thus a lower grafted polymer layer thickness. In contrast, controlled chain growth, achieved at a TEMPO molar concentration of about 10 mM, resulted in polymer layer growth that increased linearly with time. However, the increase in linear film growth with time resulted in a decrease in the rate of film growth after a 10 h reaction period from 9.7 Å/h and 7.0 Å/h at [TEMPO]=5 and 7 mM, respectively, to 4.3 Å/h at [TEMPO]=10 mM. The decrease in polymer film growth rate was presumably a consequence of the higher initial concentration of TEMPO present at the surface to reversibly cap surface-bound growing polymer chains. Therefore, a further decrease in polymer layer growth would be expected at higher TEMPO molar concentrations, as was indeed noted at [TEMPO]=15 mM where a 3.5 Å/h polystyrene film growth rate was attained.

The dependence of the NMGP grafted layer thickness on reaction temperature from 100 to 130° C. at [TEMPO]=10 mM and [M]₀=4.36 M (Table 3) showed that an optimal temperature was necessary to achieve maximum polymer layer growth. The film thickness for the controlled APPI-NMGP reaction after a 60 h reaction at 100° C. and 110° C. was less than 13% and 19%, respectively, of the film thickness created at 120° C. The observed decrease in the rate of nitroxide-mediated polymerization was consistent with the behavior for the homolytic cleavage kinetics of the TEMPO-polystyrene adduct. In that case, the rate of nitroxide-mediated polymerization was 7 times greater at 120° C., compared to characterized by linear film growth and resulted in a layer thickness of about 285 Å, achieved for 100° C., which is in reasonable agreement with the present study where an increase of 7.4 fold in the polymer layer thickness was observed (Table 3). It should also be noted that, in the current study, the polymer layer thickness decreased by more than 55% upon increasing the reaction temperature from 120° C. to 130° C. (Table 3). It is plausible that at such a high reaction temperature, the concentration ratio of polymer macroradicals to TEMPO >>1, for both chains grown in solution and at the surface, leading to insufficient availability of TEMPO for capping chain macroradicals for controlled polymer growth. Accordingly, one would expect that when the TEMPO molar concentration is less than the total concentration of growing chains in solution and at the surface, polymer grafting (i.e., “grafting to”) may be significant and thereby reduce the growth of the polymer layer.

Table 'is the polymer thickness achieved by controlled APPI-NMGP of polystyrene on silicon.

TABLE 3

| Graft Polymerization | | | Polymer Thickness |
|---|---|---|---|
| [M]₀ (M) | [T] (mM) | Temp (° C.) | (A)⁽*^{⁾} |
| 4.36 | 10 | 100 | 38.1 = 6.6 |
| 4.36 | 10 | 110 | 53.4 = 6.7 |
| 4.36 | 10 | 120 | 283.4 = 2.2 |
| 4.36 | 10 | 130 | 125.2 = 2.5 |

⁽*⁾Polystyrene layer thickness measured by spectroscopic ellipsometry at final data point.

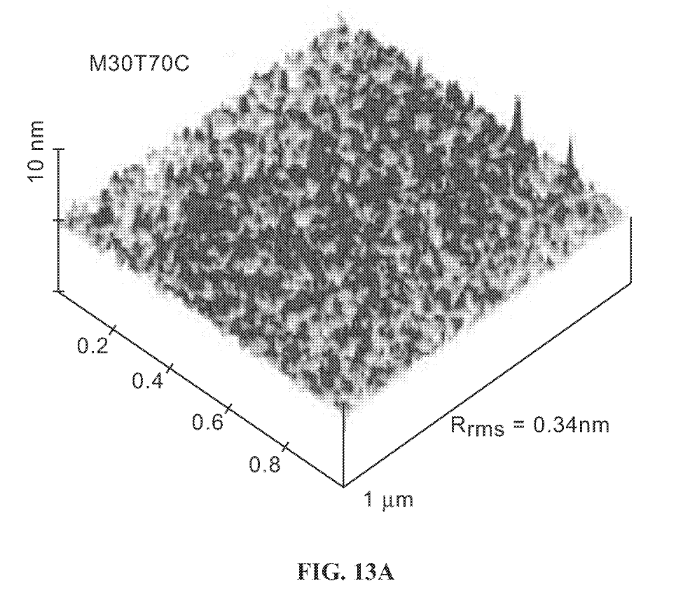

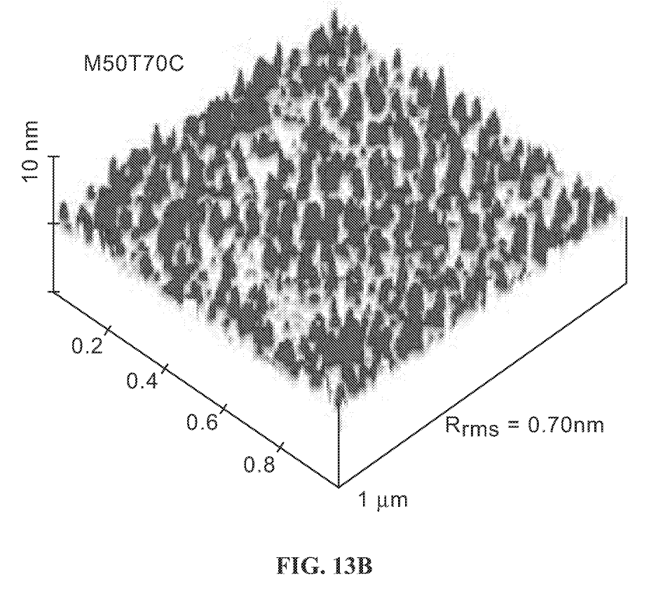

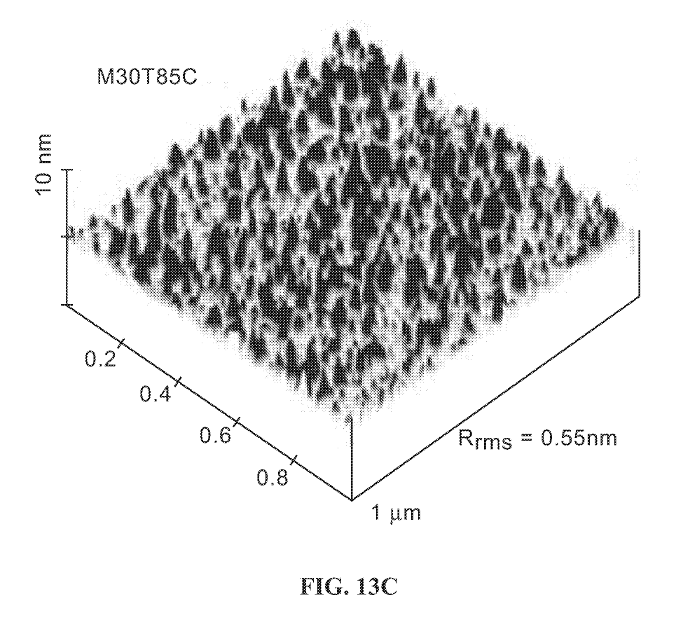

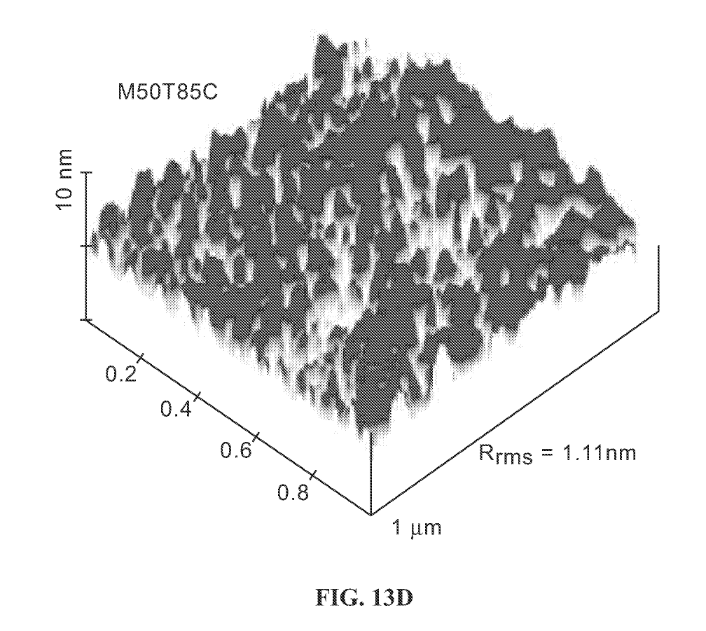

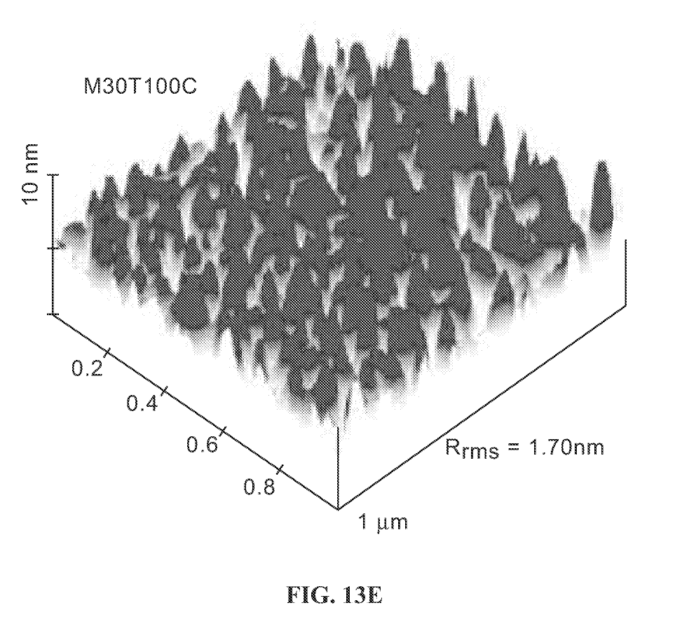

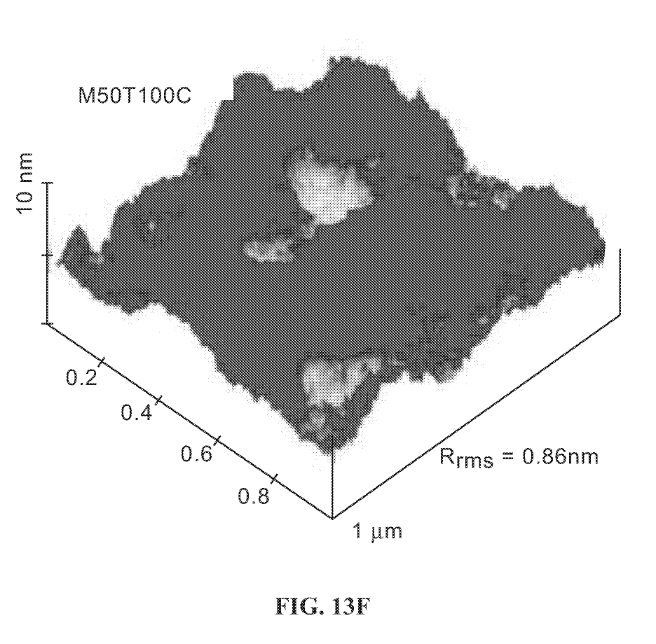

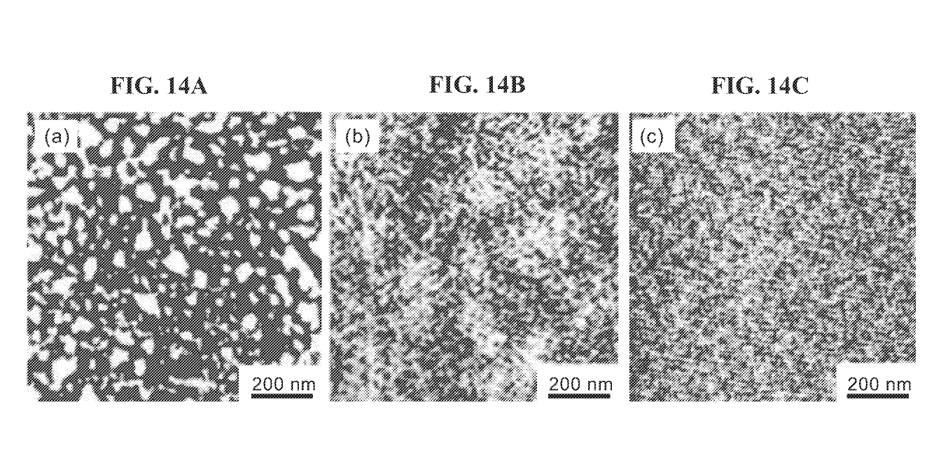

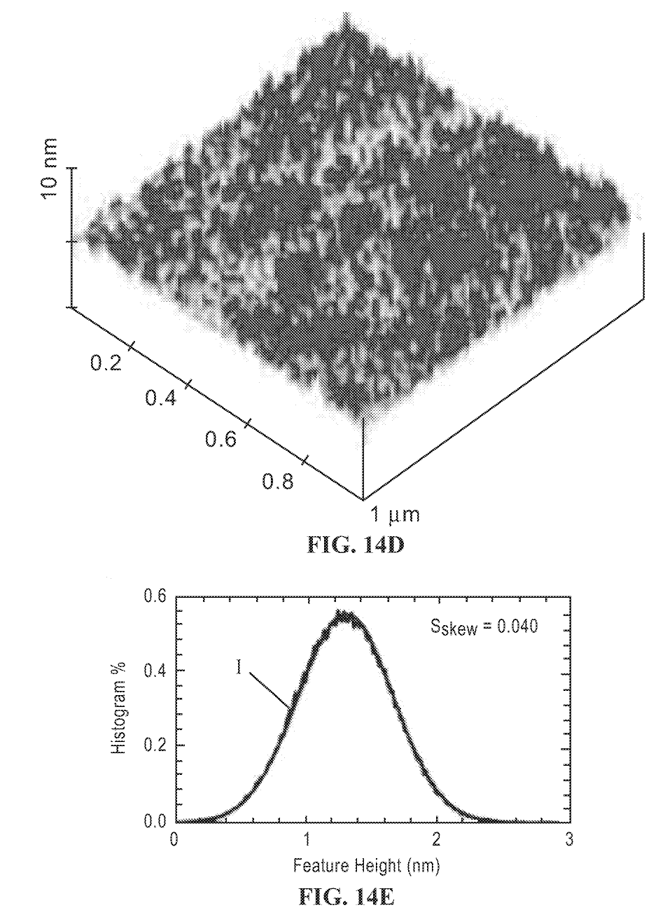

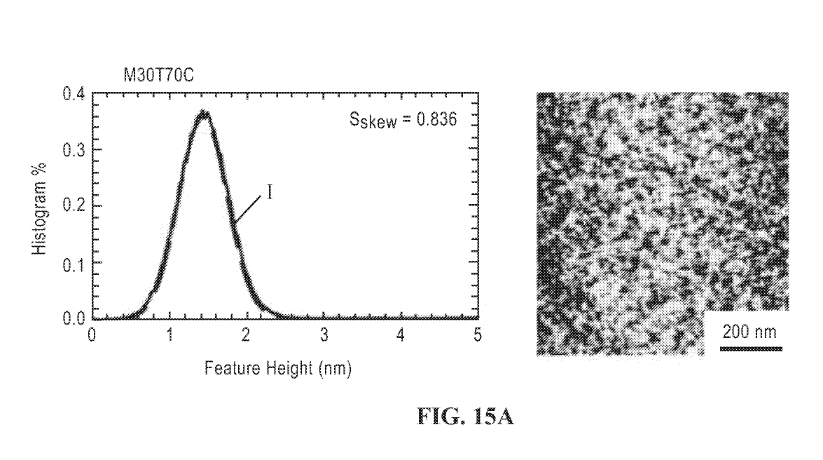

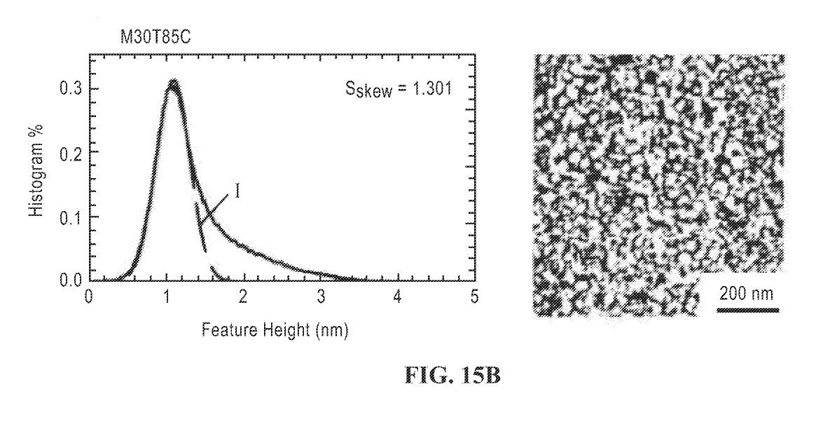

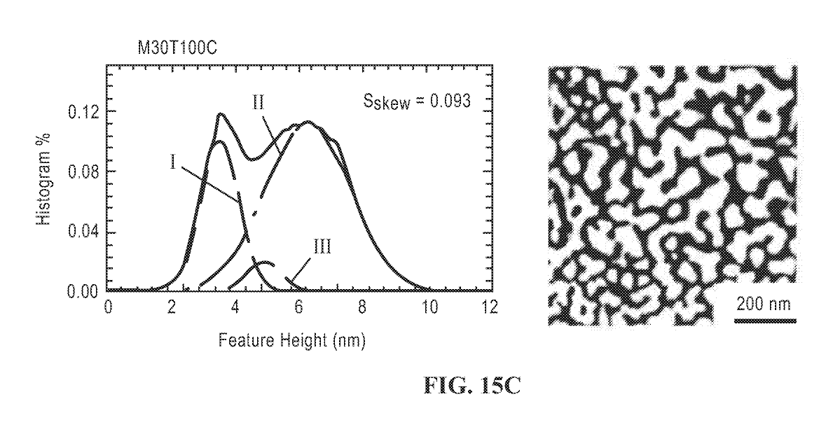

The topography of the polystyrene layers created by APPI-FRGP (FIGS. 13A-13F) and APPI-NMGP (FIGS. 14A-14E) was evaluated by AFM imaging. AFM images illustrating polymer surface features (i.e., grafted polymer chains) at reaction conditions of [M]₀=2.62 M and 4.36 M at 70° C., 85° C. and 100° C. demonstrated significant variations in surface feature density, feature height and feature diameter of grafted polymers for the different reaction condition. At the lowest initial monomer concentration and temperature reaction conditions (i.e., [M]₀=2.62 M at 70° C.), a low surface coverage of polymer features was observed, corresponding to an RMS surface roughness (Rᵣₘₛ, eq 1) of 0.34 nm, only slightly higher than that for native silicon surfaces (Rᵣₘₛ˜0.21 nm). When the temperature was increased from 70° C. to 85° C. (FIG. 13C) at [M]₀=2.62 M, the polymer feature diameter range increased from 0-5 nm at 70° C. to 15-25 nm at 85° C. Similarly, the surface roughness of the polymer film increased 471 from 0.34 nm to 0.55 nm as the reaction temperature was increased from 70° C. to 85° C., respectively. The modest 60% increase in surface roughness with temperature rise from 70° C. to 85° C., compared to almost a 3 fold increase in the film thickness for the above temperature range, as previously discussed (FIG. 7A), confirm that reaction conditions of 85° C. and [M]₀=2.62 M were suitable for creating a polymer layer of high thickness but relatively smooth surface features, while demonstrating a lesser deviation from linear film growth compared to APPI FRGP at 100° C. The increase in feature size and surface roughness with reaction temperature was noted in the AFM height distribution (FIG. 15A-15C). As the temperature was increased from 70° C. to 85° C., the skewness of the height distribution (S_{skew}, eq 2) increased by about 60% due to the contribution of feature heights in the range of 1.5-3.5 nm. The AFM analysis suggested that the density, skewness and polymer surface feature heights increased with temperature, thereby resulting in an increase in the overall surface roughness.

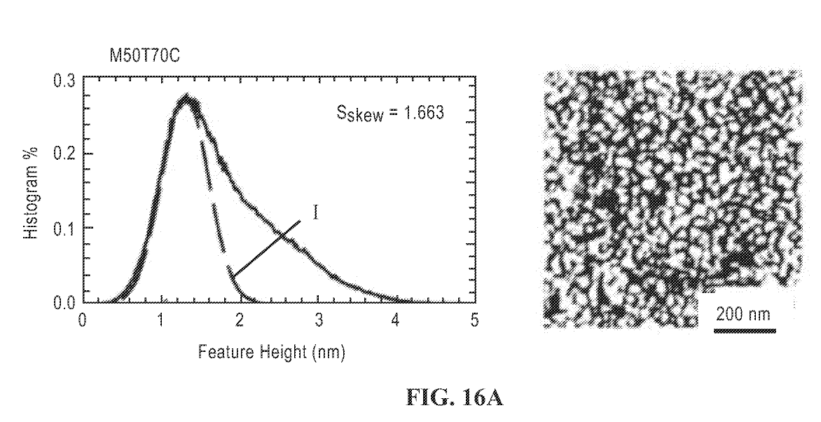

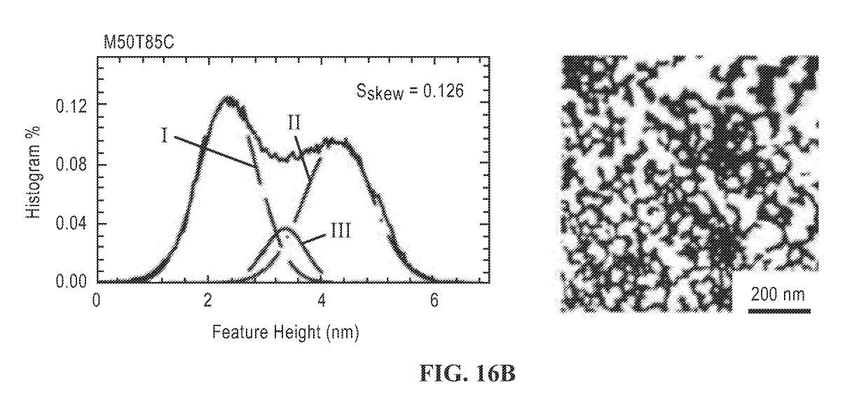

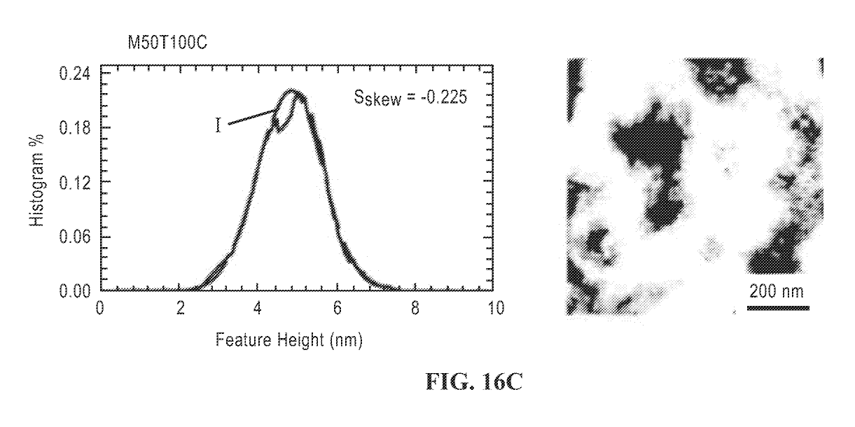

The surface roughness increased dramatically from 0.34 to 0.70 nm when the initial monomer concentration was increased from [M]₀=2.62 M to 4.36 M (FIG. 13A-13B) at 70° C. A corresponding increase in polymer feature diameters from 0-5 nm to 30-40 nm were similarly noted. The large grafted polymer features formed at the high initial monomer concentration ([M]₀=4.36 M) were evidenced by the presence of a large tail in the polymer feature height distribution from 2.2 to 5.0 nm (FIG. 16A). Likewise, at 85° C., an increase in surface roughness from 0.55 to 1.11 nm and average feature diameter from 15-25 to 50-60 nm was noted, when the initial monomer concentration was increased from [M]₀=2.62 M to 4.36M, respectively. However, the polymer surface features formed at [M]₀=4.36M and 85° C. exhibited a spatially non-uniform coverage of large globular features that were unlike surface grafted polymer features formed at 70° C. (FIG. 13D). The large polymer features surface coverage was about 38.7% of the 1×1 μm AFM image and the features were randomly and asymmetrically arranged on the surface. It is reasonable to suggest that, at the high initial monomer concentration ([M]₀=4.36M), the observed random arrangement and sizes of surface features were the result of polymer grafting of chains to the surface, as also supported by the plateau in film growth that was reached in about 6 h (FIG. 7B). Due to the presence of large and small surface features, the feature height distribution reflected a bimodal distribution (FIG. 16B), from which distinct but overlapping feature height distributions (I, II, and III) were observed.

Polystyrene grafted layers foil led at 100° C. (Regime II) and [M]₀=2.62 M displayed the largest polymer feature diameter size of 70-90 nm (FIG. 13E), with a corresponding 3 fold increase in RMS surface roughness (Rᵣₘₛ=1.70 nm), compared to graft polymerization at 85° C. The contribution of polymer grafting at 100° C. to the resulting surface topography was illustrated in the surface feature height distribution (FIG. 15C) which showed a bimodal distribution that appeared to be the result of distinct but overlapping feature height distributions (I, II, and III). Feature height distribution I, which extended from about 0.5 to 5.8 nm from the surface, was considerably narrower than feature height distribution II (0.7 to 10.4 nm) but broader than feature height distribution III (3.2 to 6.6 nm). The existence of a bimodal feature height distribution, which appeared to be composed of three feature height distributions, suggested that uncontrolled thermal solution initiation and polymer grafting to the surface resulted in a broader range of polymer chain lengths that were grafted to the surface. At a higher initial monomer concentration of [M]₀=4.36 M at 100° C., significant changes in polymer film topography were observed such as the presence of broad peaks approximately 200-300 nm in diameter and 6 to 8 nm depressions in the polymer layer. These surface features were expected, given that an increase in polymer grafting of thermally initiated polymers in solution would be predicted for uncontrolled FRGP reaction conditions at both high temperature (100° C.) and high initial monomer concentration ([M]₀=4.36 M), relative to FRGP at 70 and 85° C. at lower initial monomer concentration.

Polystyrene grafted silicon surfaces formed by controlled NMGP at [M]₀=4.36 M, T=120° C., and [TEMPO]=10 mM were characterized by a spatially homogeneous, highly dense grafted polymer phase. As expected from the linear increase in film growth with respect to time (FIG. 11), the grafted polymer surface appeared to be of a smooth surface topography (FIGS. 14B and 14D), evidenced by a surface roughness of 0.36 nm, nearly 80% less than for polymer layers produced by uncontrolled APPI-FRGP in Regime II at [M]₀=4.36 M (Rᵣₘₛ=1.70 nm). The surface roughness and feature height distribution for the controlled polystyrene grafted layer resembled the smooth features of the native silicon surface (Rᵣₘₛ˜0.21 nm). The feature height distribution (FIG. 14E) illustrated a narrow polymer feature height range of about 2.4 nm with a corresponding height distribution skewness that approached zero, further demonstrating the symmetry of the feature height distribution. It should be noted that, at the lowest TEMPO molar concentration of 5 mM (FIG. 14A), where less control over polymerization was attained, the formation of large polymer features was observed, similar to earlier findings for the APPI-FRGP method. Also, a comparison of APPI-NMGP at [TEMPO]=15 mM (FIG. 14C), compared to 10 mM, showed no significant change in the surface roughness and feature height distribution, as expected by the similar linear increase in the film growth at both TEMPO molar concentrations.

A comparison of the present controlled plasma-induced NMGP approach with other reported controlled polymerization methods, such as controlled surface initiated anionic graft polymerization of polystyrene to silicon, demonstrated that a higher density of polymer features could be attained by combining AP plasma surface treatment with controlled polymerization. For example, it was shown that the polymer layer formed by controlled anionic graft polymerized polystyrene on silicon, as imaged by AFM, resembled a dendritic structure with hole defects ranging in size from 0.2 to 0.3 μm in diameter and 11 to 14 nm in depth, dispersed throughout the layer. The impact of these surface defects resulted in an RMS surface roughness of 0.7 nm, an increase of more than 3 fold compared to the surface roughness for the present APPI-NMGP approach (Rᵣₘₛ=0.21 nm). The source of the defect morphology, created by surface initiated anionic graft polymerization, is expected to result from the low density of grafted polymers achieved on the silicon surface. In contrast, the present approach demonstrated that using atmospheric pressure plasma for surface activation, with controlled graft polymerization, may be used to achieve a polymer layer with a lower surface roughness and a higher fractional coverage of surface grafted polymers.

Free radical graft polymerization (FRGP) and nitroxide-mediated graft polymerization (NMGP) of polystyrene on silicon by atmospheric pressure (AP) plasma surface activation was demonstrated for a range of reaction conditions. In the absence of the TEMPO control agent, kinetic growth of polymer layers by APPI-FRGP demonstrated a maximum layer thickness for reaction conditions of [M]₀=2.62 M at 85° C. An increase in the initial growth rate was noted with an increase in reaction temperature (T=100° C.) and monomer concentration ([M]₀=4.36 M), due to uncontrolled thermal initiation and polymer grafting from solution. Film growth was further enhanced by a modified High-Low Temperature (HLT) graft polymerization sequence, whereby surface graft polymerization was conducted for a short 15 min initiation period at 100° C. followed by graft polymerization at 85° C. An increase in grafted film thickness was attained when using the HLT graft polymerization approach, relative to APPI-FRGP at 85° C. Surface grafting by controlled APPI-NMGP exhibited linear kinetic growth with respect to time, low surface roughness, and a uniform distribution of surface feature heights, as measured by AFM. In contrast, AFM images of grafted polystyrene layers by APPI-FRGP illustrated highly uniform surface grafting at low monomer concentration and reaction temperature, compared to heterogeneous, globular surface feature formation that were achieved at high monomer concentration and reaction temperature.

### Example

### Sorption and Diffusion in Grafted Polymer Layers

The study of polymer-solvent systems, specifically penetrant sorption and diffusion in thin films, allows for surface engineering of highly chemically selective layers with unique chemical and physical properties for applications in chemical sensors, separation membranes, and biocompatible materials. While monomer chemistry may be tuned to improve the chemical layer selectivity, the structural and physical properties of the polymer layer, such as chain packing density, polymer free volume, chain relaxation time, and glass transition temperature (T_{g}), also impact penetrant sorption and diffusion. The glass transition temperature of the polymer determines the structural properties of the layer and dictates whether the layer will exist as a rubbery polymer or a glassy polymer at a given temperature. Thin, highly stable amorphous polymer layers may be achieved by atmospheric pressure (AP) plasma-induced graft polymerization, whereby covalently bound polymer chains are formed by sequential monomer addition to plasma activated surface sites. Chain density and film thickness of the polymer layer may be controlled by adjusting the plasma operating parameters (i.e., plasma treatment time, RF power) and the reaction conditions (i.e., initial monomer concentration, temperature, reaction time). Polymer layer formation may be achieved either by AP plasma-induced rapid initiation free-radical graft polymerization (APPI-RI-FRGP), a modified APPI-FRGP approach which allows for a higher initial rate of polymerization and increased film thickness, or controlled nitroxide mediated graft polymerization (APPI-NMGP). While both methods form terminally bound polymer chains, controlled APPI-NMGP achieves a monodisperse polymer chain length distribution, due to a rapid equilibration that is established with a 2,2,6,6-tetramethyl-1-piperidinyloxy radical (TEMPO) control agent to prevent uncontrolled free radical polymerization reactions. The formation of monodisperse polymer chains, relative to polydisperse grafted chains, would be expected to alter not only the physical properties of the polymer layer, such as the polymer chain length distribution, chain packing, and segment density profile, but also the mechanical properties of the film, such as polymer swelling, thereby impacting penetrant sorption and diffusivity.

The penetrant sorption and diffusion in polymer thin films formed by APPI-RI-FRGP and APPI-NMGP were studied. Penetrant sorption was measured in a sensing chamber equipped with a polymer modified quartz crystal microbalance gravimetric device. Toluene and chloroform were chosen, in the present study, based on the range of molecular size, molecular weight, polarity, and solubility in polystyrene films. Penetrant sorption and diffusion in grafted polymer layers were compared with spin-coated polymer layers to elucidate the impact of the properties of the polymer films on viscoelastic swelling in glassy polymers.

Prime-grade silicon <100> wafers used in this study were obtained from Wafernet, Inc. (San Jose, Calif.). Native wafer samples were single-side polished and cut to 1 cm square pieces for processing. Quartz crystals used in the QCM studies were 5 MHz, AT cut piezoelectric crystals with a 1 inch diameter (Tangidyne, Marcellus, N.Y.). The quartz crystal was coated on both sides by a gold electrode (0.1-1 μm) with a titanium adhesion layer (2-20 nm), and the electrode surface area was approximately 1.3-cm², with a gold surface roughness of about 50 Å. De-ionized (DI) water was produced using a Millipore (Bedford, Mass.) Milli-Q filtration system. Hydrofluoric acid, sulfuric acid, and aqueous hydrogen peroxide (30 vol %) were obtained from Fisher Scientific (Tustin, Calif.). Chlorobenzene (99%) and tetrahydrofuran (99.99%) were obtained from Fisher Scientific (Tustin, Calif.). Styrene (99%) with catechol inhibitor (<0.1%), obtained from Sigma Aldrich (St. Louis, Mo.), was purified by column chromatography using a silica column (Fisher Scientific, Tustin, Calif.). 2,2,6,6-Tetramethyl-1-piperidinyloxy radical (TEMPO, 98%) used as a control agent for controlled nitroxide-mediated graft polymerization was obtained from Sigma Aldrich (St. Louis, Mo.) and was used as received. Polystyrene (M_{w}=35,000 g/mol, PDI=1.06), used for spin-coated polymeric surfaces, was purchased from the Pressure Chemical Company (Pittsburgh, Pa.).

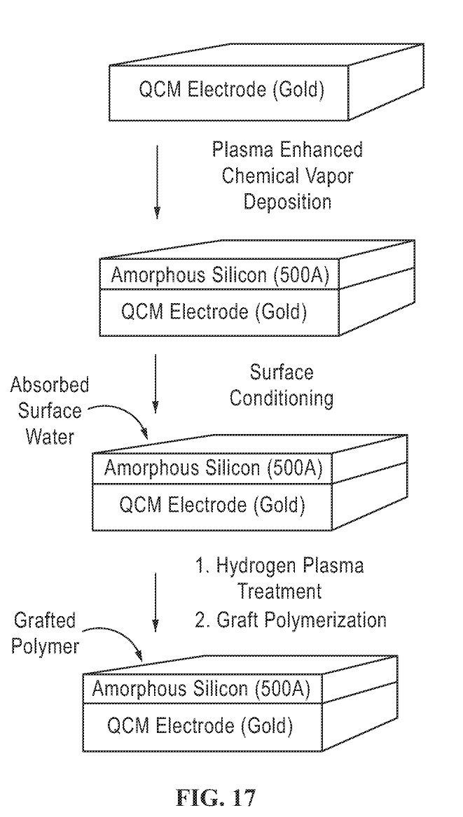

Silicon wafers, used as surrogate surfaces, were functionalized by surface graft polymerization and spin-coating to study the physical properties of the nanostructured surfaces (i.e., polymer layer growth, film thickness, and surface coverage). Quartz crystals were then modified by surface graft polymerization and spin-coating to evaluate the penetrant sorption and diffusion in polymer thin films. The QCM crystals and silicon wafers were initially cleaned for 15 sec at 25° C. and 10 min at 90° C., respectively, in a 3:1 (v/v) mixture of sulfuric acid to hydrogen peroxide. The QCM crystals were cleaned at a lower temperature and shorter cleaning time interval, compared to the silicon wafers, to reduce etching of the gold surface. After cleaning, the QCM crystals and silicon wafers were triple rinsed in DI water and dried under a nitrogen gas to remove water. An amorphous silicon film was then deposited on the top gold electrode of the QCM crystal (see FIG. 17) and on the polished surface of the silicon wafer by plasma-enhanced chemical vapor deposition (PECVD) using a Plasma-Therm 790 (St. Petersburg, Fla.) to create similar surface materials. The Plasma-Therm 790 uses a capacitively-coupled 13.56 MHz source to produce the plasma between two parallel aluminum plates. The amorphous silicon film is created by passing a mixture of silane at 9 sccm and helium at 170 sccm through a 300 W plasma and depositing the film on a fixed plate with a surface temperature of 300° C. enclosed in a vacuum chamber maintained at 500 mtorr. A 50 nm amorphous silicon film was formed on the QCM and silicon wafers at approximately 20 nm/min for the above conditions. The film thickness was confirmed by spectroscopic ellipsometry. The amorphous silicon modified QCM (aSi-QCM) and silicon wafer (aSi—Si) were then conditioned in a humidity chamber at 50% relative humidity at 22° C. for a period of 24 h.

The amorphous silicon modified QCM (aSi-QCM) and silicon wafer (aSi—Si) were hydrogen plasma treated and graft polymerized. Briefly, a mixture of 1 vol % of ultra-high purity hydrogen (99.999%) in helium (99.999%) was delivered to the atmospheric plasma (AP) source at a total flow rate of about 30 L/min. aSi-QCM crystals and aSi—Si wafers, with about a monolayer of absorbed surface water, were plasma treated at the optimal activation treatment time of 10 s and RF Power of 40 W and then were immersed in DI water. For FRGP, the plasma treated samples were graft polymerized in a mixture of styrene and chlorobenzene with an initial monomer concentration 30 vol % (M₀=2.62 M). Rapid initiated FRGP was achieved for a Step 1 time interval of 20 min at 110° C. and a Step 2 time interval of 24 h at 85° C. For controlled NMGP, the substrates were graft polymerized in a 50 vol % monomer solution (M₀=4.36 M) styrene solution in chlorobenzene at 120° C. with a TEMPO concentration of 20 mM over a period of 72 h. Following surface graft polymerization, the polymer modified aSi-QCM and aSi—Si wafers, for both FRGP and NMGP, were sonicated for 2 h in toluene at room temperature to remove surface adsorbed homopolymer, rinsed in tetrahydrofuran, and vacuum dried at 100° C.

In other embodiments of the invention, the step 1 time interval is less than 20 minutes. For example, in some embodiments the step 1 time interval is between 10 and 40 minutes. In other embodiments, the step 1 time interval is more than 40 minutes. For example, in some embodiments, the step 1 time interval is between 20 and 30 minutes. Additionally, in some embodiments the step 1 temperature is more or less than 110° C. For example, in some embodiments, the step 1 temperature is between 105° C. and 130° C. In other embodiments, the step 1 temperature is between 105° C. and 115° C.

In some embodiments, the step 2 time interval is more or less than 24 hours. For example, in some embodiments, the step 2 time interval is between 20 and 30 hours. Additionally, in some embodiments, the step 2 temperature is more of less than 85° C. For example, in some embodiments, the step 2 temperature is between 70° C. and 90° C. In other embodiments the step 2 temperature is between 80° C. and 90° C.

In some embodiments, the TEMPO concentration is less that 20 mM. In other embodiments, the TEMPO concentration is more than 20 mM. Specifically, in some embodiments, TEMPO concentration is between 5 and 20 mM. In other embodiments, the TEMPO concentration is between 2 and 30 mM.

In some embodiments, the substrates are exposed to the styrene solution at a temperature of between 70° C. and 140° C. In other embodiments, the temperature is less than 100° C. In further embodiments, the temperature is more than 140° C.

In some embodiments, the substrates are exposed to the styrene solution for a period of time shorter than 72 hours. In other embodiments, the substrates are exposed to the styrene solution for a period of time longer than 72 hours. In some embodiments, the substrates are exposed to the solution for between 60 and 80 hours.

The surfaces of the aSi-QCM crystals and aSi—Si wafers were modified by spin-coating a solution of polystyrene in toluene on the substrate surfaces. The polystyrene solution was prepared by dissolving 0.1 g of polystyrene in reagent grade toluene at ambient temperature to achieve a range of 0.1-0.5% w/w polymer concentration. Polymer films were spin-coated on the substrates by loading 1 ml of polymer solution at the center of the substrate and rotating the substrate at a speed of 2500 RPM for 25 sec using a spin-coater (model PWM32, Headway Research Inc., Garland, Tex.) in an inert nitrogen environment. The spin-coated aSi-QCM crystals and aSi—Si wafers were then dried at 100° C. in a vacuum oven to remove the solvent.

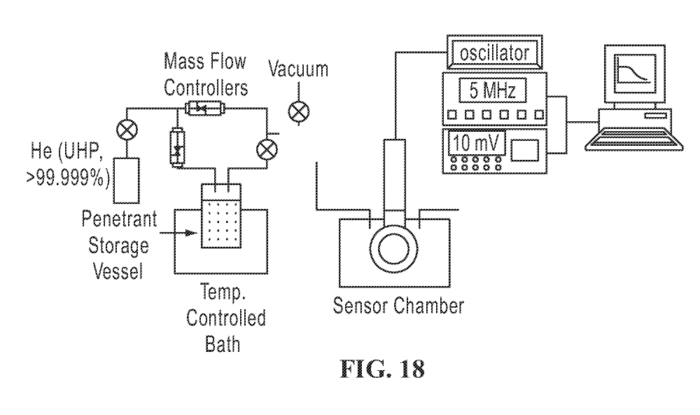

The QCM gravimetric device was composed of a QCM, QCM25 crystal controller, and QCM 100 analog controller from Stanford Research Systems (Sunnyvale, Calif.). A frequency counter (model PM6685, Fluke, Everett, Wash.) and digital multimeter (model 34401A, Agilent, Santa Clara, Calif.) were used to covert the signal from analog to digital and the data were transferred to a Labview software program (National Instruments, Austin, Tex.) for data analysis. The chemical sensing system was composed of a sensor chamber, which enclosed the QCM transducer and polymer-modified crystal, a temperature-controlled toluene vapor chamber, and the carrier gas inlet with flow controllers (see FIG. 18). The feed flow controllers (Cole-Parmer, Vernon Hills, Ill.) delivered the carrier gas and penetrant to the sensor chamber via a single inlet and outlet gate valve. The sensor chamber was sealed with parafilm M (Structure Probe, Inc., West Chester, Pa.) to prevent gas leaks. The Ultra-high purity (UHP) helium gas (>99.999%) was used as a carrier gas for the sensor study because it has a low solubility in polystyrene. The chamber, with the modified QCM crystal, was initially evacuated at 0.1 mtorr using a vacuum pump (Rotary-Type Maxima C Plus M8C, Fisher Scientific) for a period of 10 min. UHP helium gas was then delivered to the chamber at a flow rate of 50 mL/min to equilibrate the polymer-modified crystal, and the system was allowed to equilibrate for a period of approximately 1 h. During equilibration, the static capacitance that forms in the crystal electrode, holder, and connectors was reduced by adjusting the gain in the QCM controller. The residual capacitance, which was monitored at 5 min intervals, was offset by tuning the shunt capacitor on the QCM controller to minimize the static capacitance by reducing the gain necessary to sustain crystal oscillation. Sensor equilibration was completed when the frequency change of the oscillating crystal was less than 1 Hz for 10 minutes.

Gas phase sorption studies were conducted by delivering a dilute mixture of the penetrant vapor in the carrier gas to the sensor chamber. The dilute penetrant vapor mixture was created by mixing a carrier gas with the penetrant vapor generated in the headspace of the temperature-controlled toluene chamber. A toluene concentration range of 50 to 200 ppm in the gas mixture was selected by adjusting the temperature of the toluene liquid in the chamber between 20 to 30±0.1° C. (model 1252.00 water recirculator, Cole-Parmer). The sensor system was calibrated for toluene and chloroform vapor concentration by UV-Vis spectroscopy. The concentration of toluene in the vapor phase was measured over a range of 50 to 200 ppm at λₘₐₓ=207.5 nm, and chloroform vapor was measured over a range of 80 to 310 ppm at λₘₐₓ=220.5 nm. The sensor was regenerated by passing a pure helium feed stream into the sensor chamber at ambient temperature (about 22° C.), thereby desorbing the penetrant vapor from the polymer thin film.

Styrene was graft polymerized onto amorphous silicon coated substrates (aSi—Si and aSi-QCM) using a two-step plasma-induced graft polymerization approach combining surface activation by atmospheric pressure (AP) plasma surface treatment with styrene graft polymerization by monomer addition to activated surface sites. It was noted in a previous study that the surface density of grafted polymer sites was dependent on the hydrogen plasma processing parameters (i.e., surface conditioning, plasma treatment time, and RF power). Also, previous work on AP plasma-induced graft polymerization of polystyrene on silicon demonstrated that the reaction conditions, specifically the initial monomer concentration and temperature, determined the surface-bound polymer chain properties (i.e., polymer layer thickness). Grafted polymer layers were compared with spin-coated polymers to elucidate the impact of the chain orientation, covalent attachment of the polymer to the substrate surface, and chain density on vapor penetrant sorption and diffusion. Grafted polymer layers formed by atmospheric pressure plasma-induced rapid initiation FRGP (APPI-RI-FRGP) and controlled atmospheric pressure plasma-induced nitroxide-mediated graft polymerization (APPI-NMGP) were also compared to determine the impact of the grafted polymer structure (i.e., chain density, chain length distribution) on penetrant diffusivity.

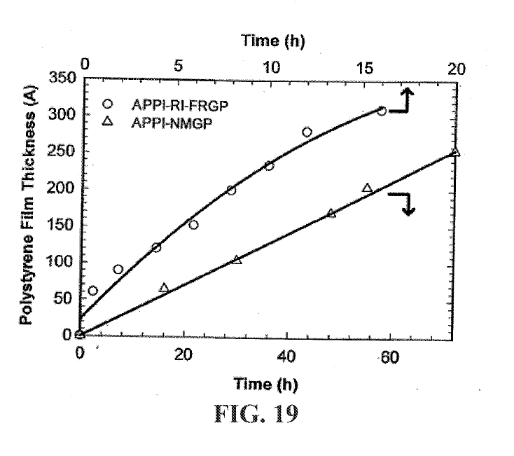

The grafted polystyrene film growth (i.e., evolution of film thickness) for plasma-induced graft polymerization of styrene onto amorphous silicon (see FIG. 19) exhibited polymer layer growth approaching a plateau for APPI-RI-FRGP and a linear increase in the polymer layer thickness for APPI-RI-FRGP and controlled APPI-NMGP, respectively. The polymer layer achieved by APPI-RI-FRGP was characterized by polymer layer growth that increased with reaction time to achieve a film thickness of about 10, 15 and 20 nm for a reaction time of about 3, 6, and 8 h, respectively. Polymer layer growth by controlled APPI-NMGP achieved a film thickness of about 10 and 20 nm after a reaction time of 30 and 55 h, respectively. These conditions were used to create polymer grafted surfaces for penetrant sorption and diffusion studies. The behavior of APPI-NMGP layer growth is consistent with previous studies on controlled surface graft polymerization of polystyrene in which the growing chain is reversibly capped by the control agent (e.g., TEMPO). Reversible capping of the growing radical chain reduces the rate of surface polymerization, leading to a linear growth rate with respect to time. Chemical surface structuring by APPI-RI-FRGP and APPI-NMGP was confirmed by an increase in the water contact angle following surface modification. Compared to the contact angle (CA) of the native amorphous silicon substrates (CA=71-73°), the polymer layers formed by APPI-RI-FRGP and APPI-NMGP achieved CA=90° for a film layer thickness of 10 nm (see Table 4). From previous studies, the contact angle for surfaces modified by spin-coated polystyrene approached a plateau at CA˜87 to 90° for grafted and spin-coated polymer films. These findings suggest that both surface structuring techniques were successful in modifying the surface chemistry, resulting in similar surface chemistry properties which were suitable for studying penetrant sorption and diffusion.

TABLE 4

| | | | Polymer | Polymer | Peak | | |
|---|---|---|---|---|---|---|---|
| | | | Layer | Volume | Number | Feature | Contact |
| | Rᵣₘₛ | | Thickness | (nm³/μm²) | Density | Diameter | Angle |
| Graft Conditions | (nm) | S_{skrw} | (nm) | (10²) | (feat/μm²) | (um) | (deg) |
| aSi-Silicon Surface | 0.28 | 0.12 | — | — | — | — | 71-73 |
| Polymer Spin-Coat | 0.37 | 0.10 | 10.0 | 0.174 | 256 | 10-20 | 90 |
| APPI-RI-FRGP^{a,b} | 0.65 | 0.17 | 9.9 | 0.233 | 568 | 5-40 | 90 |
| APPI-NMGP^{a,c} | 0.35 | −0.05 | 10.0 | 0.136 | 173 | <10 | 90 |

^{a}Plasma surface activation conditions: treatment time = 10 s and RF power = 40 W.
^{b}M₀ = 30 vol % styrene; T₁ = 110° C. and T₂ = 85° C.; t = 16 h.
^{c}M₀ = 50 vol % styrene; T = 120° C.; t = 72 h.

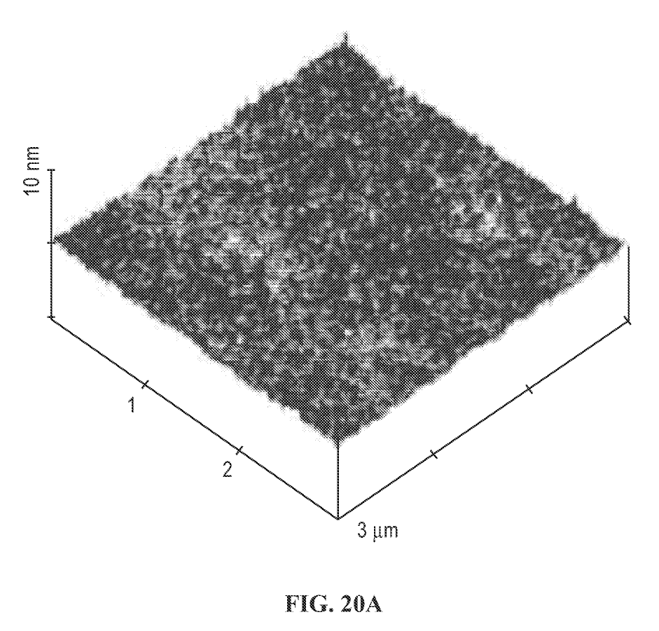

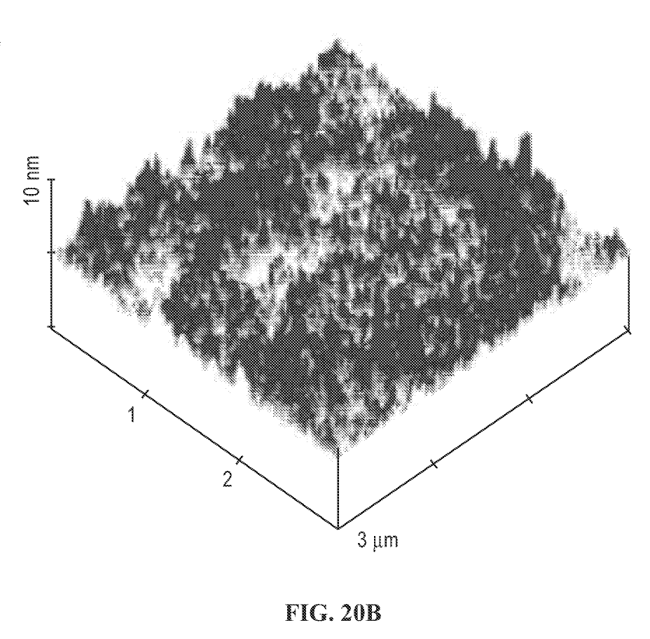

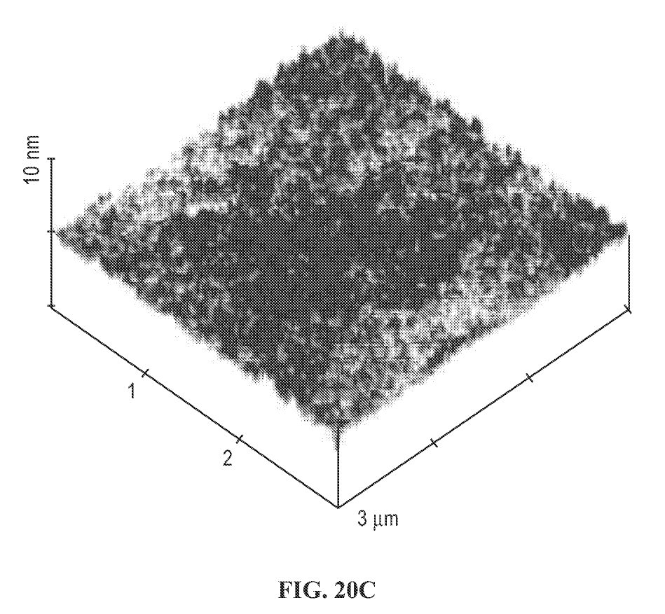

The topography of the polystyrene layers created by spin-coating, APPI-RI-FRGP and controlled APPI-NMGP was evaluated by AFM imaging (see FIG. 20A-20C). AFM images illustrating polymer surface features (i.e., grafted polymer chains) for spin-coated, uncontrolled (APPI-RI-FRGP) and controlled (APPI-NMGP) surface graft polymerization demonstrated slight variations in surface feature density, feature diameter, and feature height (i.e., height of polymer surface features) of grafted polymers (see Table 4). Polymer layers formed by controlled APPI-NMGP exhibited the lowest surface roughness (Rᵣₘₛ=0.35 nm) at a layer thickness of 10 nm (see Table 4), only a 25% increase in surface roughness compared to the amorphous silicon wafer (Rᵣₘₛ=0.25 nm). In comparison, an increase in surface roughness of 6% and 86% was observed for the polystyrene layer formed by spin-coating (Rᵣₘₛ=0.37 nm) and APPI-RI-FRGP (Rᵣₘₛ=0.65 nm), respectively, compared to APPI-NMGP. The increase in surface roughness for the layers formed by spin-coating and APPI-RI-FRGP was due to the increase in polymer surface volume, surface feature density, and the feature diameter. The polymer volume increased by 28% and 71% and the surface feature density increased by 48% and 128% for the spin-coated and APPI-RI-FRGP polystyrene films, compared to the APPI-NMGP films. The decrease in polymer surface volume and surface feature density suggest that the polystyrene layers formed by controlled APPI-NMGP exhibit a lower surface roughness due to the contribution of polymer surface chains than spin-coating or APPI-FRGP. This is evidenced by noting that the average polymer feature diameter observed for APPI-NMGP is less than 10 nm, compared to a range of 10-20 rim for spin-coated polystyrene films and 5-40 nm for layers formed by APPI-RI-FRGP.

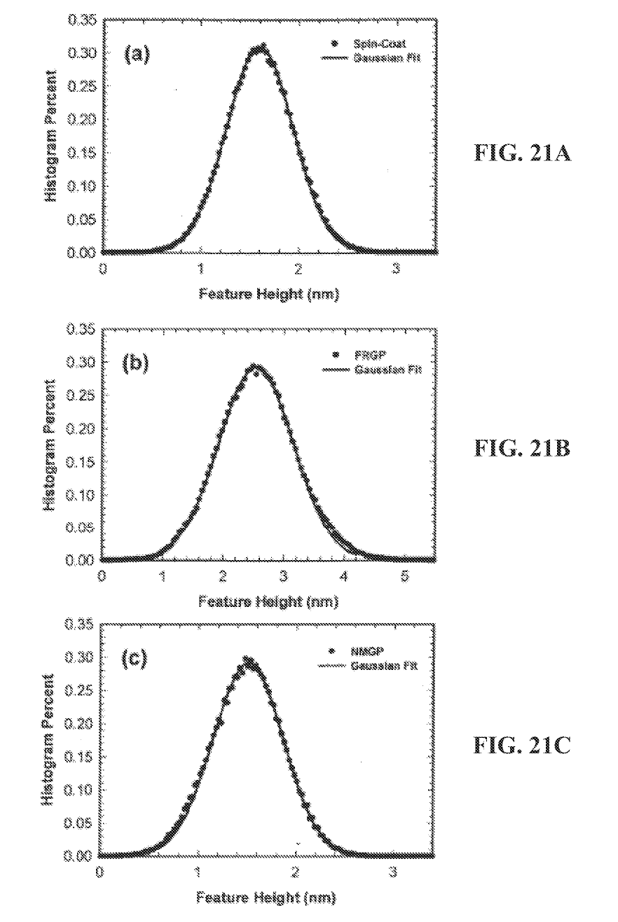

The contribution of larger feature diameters to the surface topography, observed in polymer layers formed by APPI-RI-FRGP, resulted in a 3.4 fold increased skewness in the feature height profiles (see Table 4), compared to the polymer layers formed by APPI-NMGP. The feature profiles were fitted to Gaussian distributions to the right of the peak to elucidate the contribution of larger surface features to the skewness of the distribution (see FIGS. 21A-21C). For the polymer layer formed by APPI-RI-FRGP, the increased feature diameter of 5-40 nm corresponded to a small tail in the distribution, resulting in an S_{skew} of 0.17 (see Table 4). In contrast, the polymer layers formed by controlled APPI-NMGP exhibited a near-Gaussian distribution, with an S_{skew} of −0.05. The spin-coated polystyrene layer (S_{skew}=0.10) exhibited a skewness in the feature height profile similar to that of the APPI-RI-FRGP layer (S_{skew}=0.17) (see Table 4). The increase in the average feature diameter of 10-20 nm for spin-coated polystyrene, compared to a feature diameter of less than 10 rim for APPI-NMGP, resulted in an increase in the asymmetry (i.e., skewness) of the feature height distribution. These findings confirm that the polymer layers formed by APPI-NMGP exhibit the most uniform surface feature height coverage, relative to spin-coating or APPI-RI-FRGP.

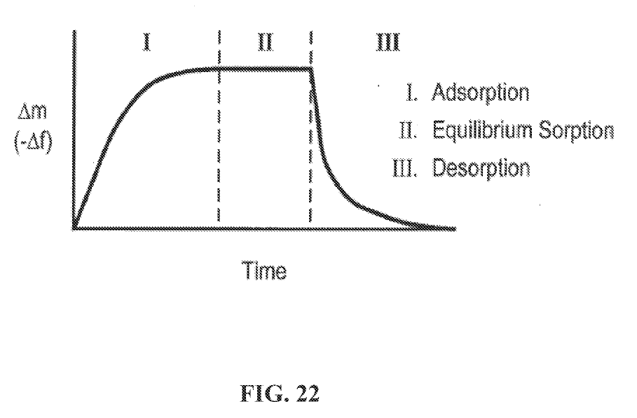

Mass uptake in thin polymer films is a function of not only the chemical potential of the penetrant in the polymer layer but also the polymer surface structure, viscoelastic properties of the polymer chains, and the interaction of the substrate surface with the polymer thin film. Transport and thermodynamic models were used, in the current study, to derive information regarding the physical nature of the grafted layer, with respect to spin-coated materials. The apparent penetrant effective diffusivity may be determined by analyzing the characteristic Fickian sorption profile (see FIG. 22) for penetrant uptake in the polymer films. Penetrant vapors, when introduced to a polymer film, diffuse into the polymer layer and expand the polymer chains, resulting in an increase in the mass of the film with respect to time (Step 1). The evolution of the concentration profile in the polymer film can be described by a simple one-dimensional Fickian diffusion model for a semi-infinite polymer film, whereby an apparent diffusion coefficient is utilized. Accordingly, the diffusion model is given as

$$\frac{\partial C}{\partial t} = {D}_{f} \frac{{\partial }^{2} C}{\partial {z}^{2}} \qquad ( VI .1 )$$

where C is the penetrant concentration in the film (moUL), D_{f} is the apparent effective penetrant diffusivity (cm²/sec), t is time (sec), z is the penetration depth into the film (cm, where z=0 is the film upper surface). A solution to eq. V1.1 may be obtained by using the following boundary conditions

$$\begin{matrix}C ( 0 , t ) = {C}_{s} & ( VI .2 ) \\ \frac{\partial C ( l , t )}{\partial z} = 0 & ( VI .3 )\end{matrix}$$

and the initial condition for penetrant vapor in the polymer film

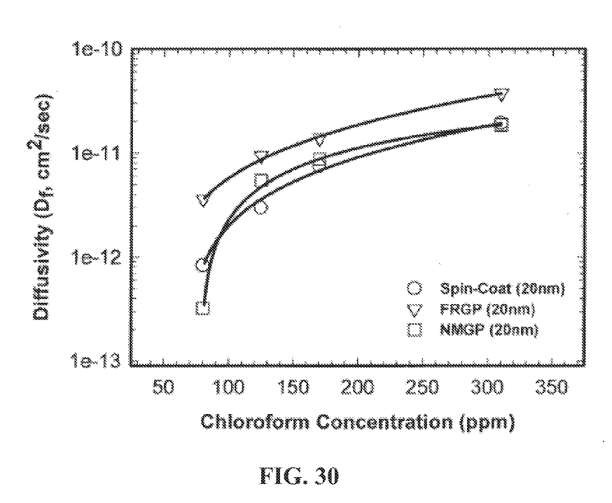

C(z,0)=0,0≦z≦l (VI.4)

where l is the polymer layer thickness. The analytical solution of eq. VI.1 for 1-D mass uptake in a polymer film is then given by the following expression:

$$\frac{C ( t )}{{C}_{s}} = 1 - \frac{4}{π} {\sum }_{n = 0}^{∞} \frac{{( - 1 )}^{n}}{2 n + 1} exp ( \frac{- {{D}_{f} ( 2 n + 1 )}^{2} {π}^{2} t}{4 {l}^{2}} ) cos \frac{( 2 n + 1 ) π z}{2 l} \qquad ( VI .5 )$$

where Cₛ is the penetrant concentration at the polymer surface (z=0). The penetrant mass in the film at infinite time is then obtained by the integration of the penetrant concentration with

$$respect to depth ( m ( t ) = {\int }_{0}^{l} C ( t ) d z ) [ 28 ] \text{:} \\ \frac{m ( t )}{{m}_{∞}} = 2 {( \frac{{D}_{f} t}{{l}^{2}} )}^{1 / 2} ( {π}^{- 1 / 2} + 2 {\sum }_{n = 1}^{∞} {( - 1 )}^{n} ierfc ( \frac{nl}{\sqrt{{D}_{f} t}} ) ) \qquad ( VI .6 )$$

where m(t) and m_{∞}, are the penetrant mass in the polymer film at time t and at equilibrium, respectively. The application of this solution to the present system is based on the assumption that surface absorption is negligible (i.e., a decrease in penetrant at the interface is primarily due to diffusion in the polymer film), penetrant diffusivity at the polymer vapor interface is spatially homogeneous and is constant with time (infinite dilution conditions), and the polymer is modeled as a semi-infinite film with negligible boundary effects. For Fickian penetrant diffusion in a polymer thin film, the mass uptake (m(t)/m_{∞}) increases linearly for a given \sqrt{t}/l when the diffusion coefficient is constant with penetrant concentration and penetration depth as well as independent of the equilibrium sorption capacity m_{∞}. A non-linear increase in mass uptake with time, however, has been reported for case II glassy polymers, such as polystyrene, due to the dependence of the non-Fickian penetrant diffusivity on polymer chain dynamics and the penetrant concentration. Non-Fickian penetrant diffusivity in case II glassy polymers has been previously attributed to the reduced mobility of polymer chains in the film, either due to polar interactions between functional groups, or, in the case of polystyrene, due to the steric effects of high molecular weight functional groups which interact and prevent elastic swelling and contraction in the polymer film. In these studies, it has been reported that the sorption curve is an S-shaped sigmoidal curve for diffusion of penetrant in case II glassy polymers. Inspection of the penetrant sorption curve for the spin-coated polymer film (at 20 nm) shows that penetrant diffusion follows an S-shaped (i.e., sigmoidal), non-Fickian mass uptake profile (see FIG. 30). From the behavior of the mass sorption profile, it is evident that the diffusivity is concentration dependent, as expected for non-Fickian diffusion, and changes with mass uptake for the spin-coated polymer. The initial toluene penetrant diffusivity of D_{f}=1.26×10⁻¹³ cm²/sec (R²=0.958) was reduced by almost a factor of 10 to yield a

$${D}_{f} = 1.50 \times {10}^{- 14} {cm}^{2} \text{/} sec ( {R}^{2} = 0.923 ) at \frac{m ( t )}{{m}_{∞}} ∼ 0.2 .$$

However, at

$$0.2 \leq \frac{m ( t )}{{m}_{∞}} \leq 0.5 ,$$

an increase in penetrant diffusivity to D_{f}=1.86×10⁻¹³ cm²/sec (R²=0.982) was observed, approaching the initial penetrant diffusivity. The S-shaped penetrant concentration profile occurs because the spin-coated polymers are semi-crystalline thin films, with a large fraction of the chains arranged longitudinally (parallel to the substrate) due to the lateral shear forces exerted during the spin-coating process. The polymer chains stretched parallel to the surface consequently result in a high chain packing efficiency and reduced free volume in the polymer film. Glassy polymers, with spin-coated polymer chains arranged in a layered structure along the depth of the polymer film, exhibit an elastic region and a viscous region when swelled in a good solvent. The penetrant initially diffuses to a finite depth, whereby polymer chains at the surface and subsurface undergo instantaneous elastic swelling, as observed by the high initial penetrant diffusivity (see FIG. 30). However, a rigid, unswollen core, described as the “viscous region,” exists below the elastic region and imposes a constraint by exerting a compressive stress on the swelled subsurface polymers. In the non-swollen region, penetrant diffusion is reduced and a steep concentration gradient is fowled. The stress, which prevents longitudinal swelling, reduces the penetrant diffusivity and a steep concentration gradient is formed. Once the polymer in the core is solubilized (i.e., swelled), the penetrant diffuses into the polymer layers, re-establishing the penetrant diffusivity in the elastic region. In this way, the sequential swelling of polymer layers results in the development of a moving penetrant front, separating the swollen from the unswollen polymer layers, with penetrant diffusivity controlled by slow diffusion into the unswollen core. Therefore, for glassy polystyrene films, one would expect a non-Fickian diffusivity for penetrant sorption.

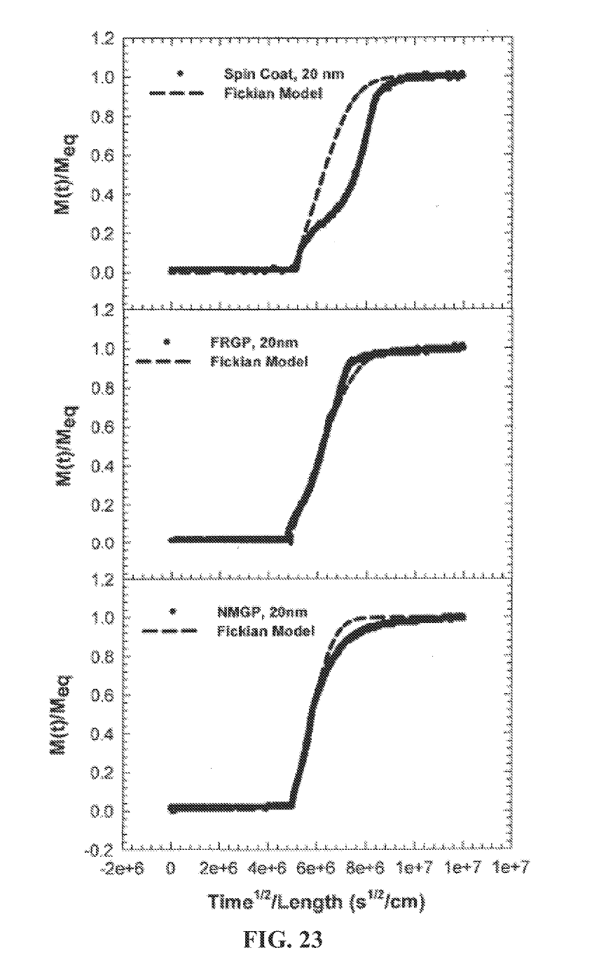

In contrast, a linear increase in mass uptake with respect to \sqrt{t}/l was observed in the semi-infinite regime (m(t)/m_{∞}<0.7) for penetrant diffusion in both APPI-RI-FRGP and controlled APPI-NMGP grafted polymer films (see FIG. 23). The unexpected diffusive behavior of penetrant in glassy grafted polystyrene layers was presumably due to the 1) mechanical (i.e., viscoelastic polymer swelling) and 2) physical properties (i.e., polymer density) of the grafted polymers. In a poor solvent (e.g., air), grafted polymer chains, where the Flory radius, exist in a coiled structure. In the presence of a good solvent, the polymer chains swell normal from the surface as a result of the driving force for intermolecular interactions between the polymer and the penetrant. The reduced degrees of freedom for chain movement (i.e., chain swelling) at the surface ensures not only the reproducible surface chain extension but also the unilateral swelling of a dense polymer phase from the surface. In addition, the physical properties of the grafted polymer films, such as surface chain density, may also impact penetrant diffusivity. Porous glassy polymer films, composed of a lower density of polymer chains arranged in unique structures, have previously been fabricated to increase penetrant sorption in case II glassy polymers. For example, it has been reported that vapor sorption studies of helical nanopores in the mesophase form of syndiotactic polystyrene thin films resulted in a higher penetrant solubility at a lower activity, compared to atactic polystyrene. In the same way, it is plausible to suggest that the reduced chain density and chain packing efficiency in amorphous grafted polystyrene layers would result in an increased polymer free volume, leading to an increased diffusivity and solubility, relative to semi-crystalline spin-coated polymer films. Indeed, the mechanical and physical properties of the grafted polymer layers resulted in a near-Fickian diffusion behavior for grafted layers formed by both APPI-RI-FRGP and APPI-NMGP (see FIG. 23). However, it should be noted that for the case when the mass uptake approached the equilibrium sorption capacity (i.e., (m(t)/m_{∞}≈1), the layers formed by APPI-RI-FRGP and APPI-NMGP exhibited a positive and negative deviation, respectively, from Fickian diffusivity (see FIG. 23). The positive deviation observed in APPI-RI-FRGP layers is presumably due to the physical properties of the grafted polymer layers. For grafted layers tethered to a non-porous surface, a segment density profile for polymer chains attached to a substrate surface in a poor solvent. At the substrate wall, the presence of short chain length polymers and non-activated surface sites results in a reduced monomer density at the substrate surface. However, the segment density profile approaches a maximum away from the surface due to the compressed structure of the coiled grafted polymer chains. According to the Free-Volume Theory model for penetrant diffusion through polymer films, penetrant diffusivity increases with the free volume available for the penetrant to migrate. Therefore, it is plausible to suggest that penetrant diffusion and sorption in the polymer-substrate interfacial region would increase, resulting in a positive deviation from Fickian diffusion. In contrast, grafted layers formed by NMGP are composed of polymer chains of a narrow or monodisperse chain length. For a highly dense, monodisperse grafted polymer layer, it may be suggested that a negligible monomer density profile exists at the substrate-polymer interface, and therefore one would not expect a positive deviation due to polymer free volume. However, because of the reduced degrees of freedom available for polymer chains formed by NMGP to expand when swelled, a negative deviation (i.e., reduced penetrant diffusion) in Fickian diffusion is observed.

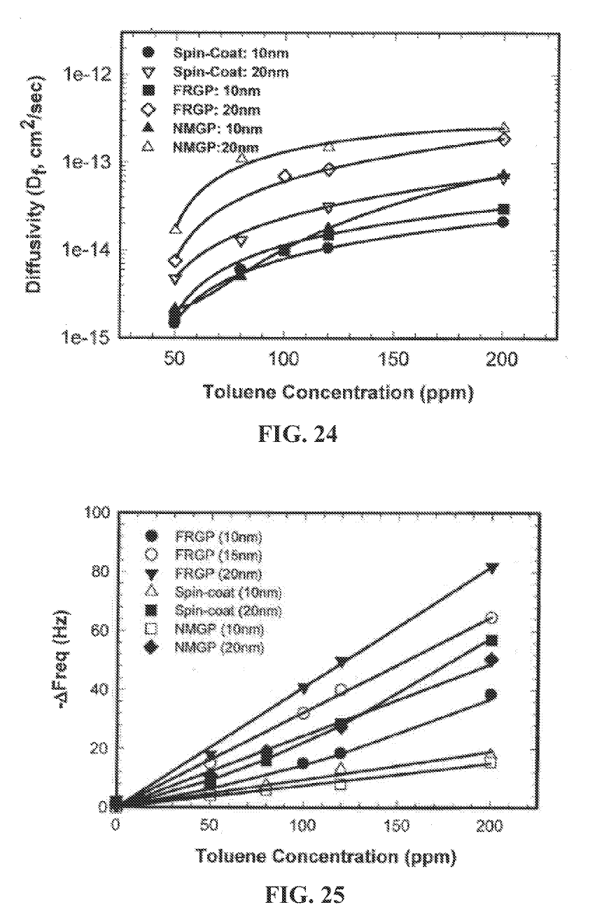

The evolution of diffusivity with penetrant concentration showed that APPI-RI-FRGP and APPI-NMGP grafted films exhibited an order of magnitude increase in toluene penetrant diffusivity, for the range of 50 to 200 ppm, relative to the spin-coated polymer films (see FIG. 24). Relative to the spin-coated polymer films (at 20 nm), an increase of 1.4 and 3.4 fold in diffusivity for the APPI-RI-FRGP and APPI-NMGP films (both at 20 nm), respectively, was observed at a 200 ppm penetrant concentration. The decrease in penetrant diffusivity for spin-coated polymers was due to the mechanical and physical properties of the films, as noted previously. Also, the non-linear increase in diffusivity with penetrant was consistent with previous studies showing that diffusivity is a function of both the penetrant concentration in the polymer and the swelling of the polymer film. It was interesting to note, however, that the penetrant diffusivity was higher at both 10 and 20 nm film thicknesses for polymer layers formed by APPI-NMGP, relative to APPI-RI-FRGP. The difference in penetrant diffusivity may be explained by considering the contribution of the free hole volume to polymer swelling. Layers formed by APPI-NMGP, compared to APPI-RI-FRCP, are composed of highly dense, monodisperse chain sizes and therefore have a lower free volume per unit thickness. Therefore, it may be postulated that the driving force would be greater for the reduced free hole volume grafted layers, leading to a shorter time interval for polymer swelling by penetrant diffusion. Also, an increase in the enthalpy of mixing ΔHₘᵢₓ, expected for a higher density of monomer units per volume of polymer, would similarly result in an increase in the chain entropy, leading to a swelled structure.

The penetrant solubility in the polymer layer is the isothermal equilibrium sorption capacity of the polymer thin film. The equilibrium sorption capacity is the maximum concentration that may be adsorbed in the polymer film, of a given film thickness and chain density, for a penetrant vapor concentration. The magnitude of the sorption capacity may be determined from the mass uptake observed in Step 2 of FIG. 22. Once the equilibrium sorption capacity is achieved, there is no further change in mass uptake

$${( i . e . , \frac{d m}{d t} \vert}_{II} = 0 )$$

for a feed stream of a given constant concentration. The equilibrium sorption capacity of the polymer film may be defined as Cₚₒₗ=C|ₜ₌ₜ_{_{steady state}}−C|ₜ₌ₜ_{₀} with initial conditions of C|ₜ₌ₜ_{₀}=0. The partition coefficient, then, is simply the following:

$$K = \frac{[ {C}_{pol} ]}{[ {C}_{gas} ]} \qquad ( VI .8 )$$

where C_{gas}=mg tolₐᵢᵣ/cm³ pol and Cₚₒₗ=mg tolₚₒₗ/cm³ pol are the concentrations of solute concentrations in the gas phase and polymer film, respectively. The polymer volume was determined from the area of the QCM electrode surface and the calculated polymer layer thickness.

An increase in penetrant sorption for APPI-RI-FRGP grafted polymer films, compared to spin-coated films, was observed in differential penetrant sorption experiments where 10 to 20 nm thick polymer layers were exposed to a range of 50 to 200 ppm toluene penetrant vapor concentrations (see FIG. 25). For APPI-RI-FRGP polymer films and spin-coated polymer films, mass uptake, noted by an increase in −Δfreq, increased with penetrant concentration in the polymer film, as expected for a soluble penetrant-polymer system with a high enthalpy of mixing. Also, an increase in film thickness from 10 to 20 nm for both APPI-RI-FRGP and spin-coated polymer films led to increased penetrant uptake in the polymer thin films, as noted in previous studies. However, APPI-RI-FRGP polymer layers, compared to spin-coated polymers, exhibited an increase in mass uptake of about two fold and 30% for film thicknesses of 10 and 20 nm, respectively. Also, a near-linear increase in penetrant sorption with respect to concentration for the grafted polymer film was noted with an R² correlation of 0.9989 and 0.9986 for the 15 and 20 nm films, respectively. In contrast, the spin-coated polymer film exhibited a non-linear increase in penetrant sorption over the concentration range of 50 to 200 ppm studied in the present work. The non-linear increase in mass sorption for the spin-coated film suggests that, at low penetrant concentration of 50 ppm, the magnitude of the concentration gradient required to solubilize the unswollen core is reduced and therefore leads to a mass decrease in the penetrant that may diffuse into the polymer layer. In contrast, the near-linear increase in mass uptake with penetrant concentration noted for APPI-RI-FRGP polymer films suggests that polymer swelling leads to a spatially uniform penetrant per monomer unit concentration profile. It was also interesting to note that both APPI-RI-FRGP and spin-coated polymer layers exhibited an increase in penetrant mass uptake compared to APPI-NMGP layers. However, as discussed previously, the decrease in the penetrant volume sorbed in the grafted layer formed by NMGP may presumably be due, in part, to a higher segment chain density in the polymer layer and at the polymer-solid interface. The increase in segment chain density for APPI-NMGP, compared to APPI-RI-FRCP, would reduce penetrant free volume transport in the polymer layer. Also, due to the higher segment chain density at the polymer-solid interface, the chain mobility of polymers tethered to the surface would reduce the chain entropy and swelling, leading to a decrease in penetrant sorption at the surface.

Sorption-desorption of penetrant vapors in polymer thin films may be characterized by the illustration in FIG. 22. In the limit in which the carrier gas is insoluble in the polymer film, the change in mass uptake is Δm=0 for penetrant diffusion (where Δm=m_{f,p}−m_{0,p} and m_{0,p} and m_{f,p} are the initial and final mass of the polymer film, respectively). Also, the time required for sorption (tₛₒᵣₚ) and desorption (t_{desorp}) of the penetrant may be calculated from FIG. 22 as tₛₒᵣₚ/_{desorp}=t_{f,eq}−t₀ where t₀ is the initial time for mass uptake/removal where

$$\frac{d m}{d t} \neq 0$$

and t_{f,eq} is the final time where sorption/desorption equilibrium is reached and

$$\frac{d m}{d t} = 0.$$

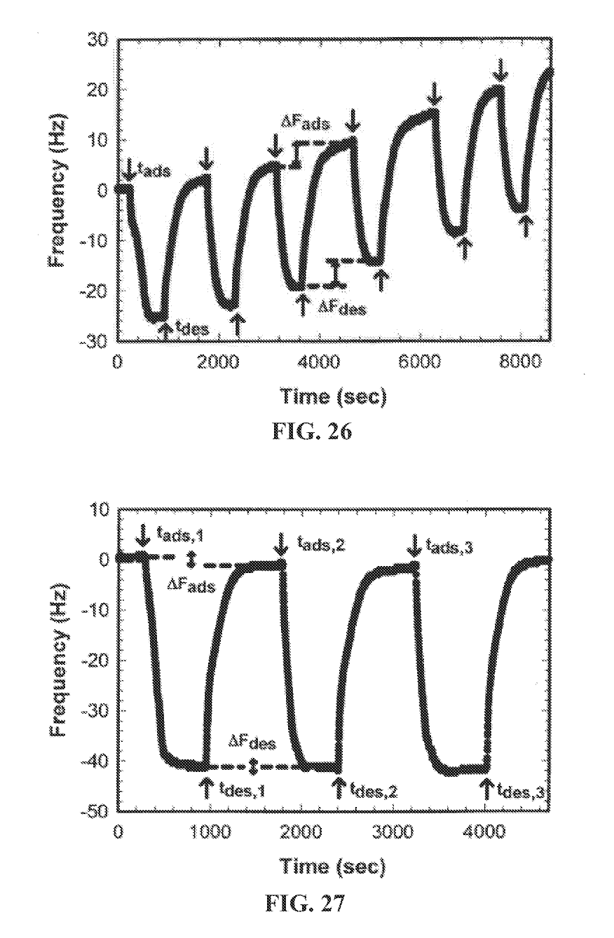

For spin-coated polymer films, adsorption capacity decreased for each successive cycle, as observed in the sorption-desorption curve for a film thickness of 20 nm and 120 ppm penetrant concentration (see FIG. 26). In each cycle, a deviation in mass change was observed with m_{f,p}<m_{0,p}, corresponding to a frequency shift of Δf˜+2 to 4 Hz and a mass change of Δ_{mA}˜−25.4 to −70.8 ng/cm². One may argue that the apparent decrease in mass uptake with each successive cycle may be due, in part, to plasticization of the glassy polymer, preventing the removal of penetrant during desorption. The decrease in penetrant mass uptake with successive cycles, noted in FIG. 26, suggested that a finite penetrant volume may have remained in the spin-coated polymer layer after desorption. However, there is a negligible mass change (Δm) for each cycle, suggesting that the sorption capacity of the polymer film does not change with multiple cycles. Instead, it is plausible to suggest that the change in mass is related to polymer delamination from the surface for spin-coated polymers, as was previously noted in the viscoelastic film studies. Polymer delamination from the surface results in an apparent mass loss, resulting in a decreased dampening of the crystal oscillations. These combined behaviors may explain the change in mass uptake with time.

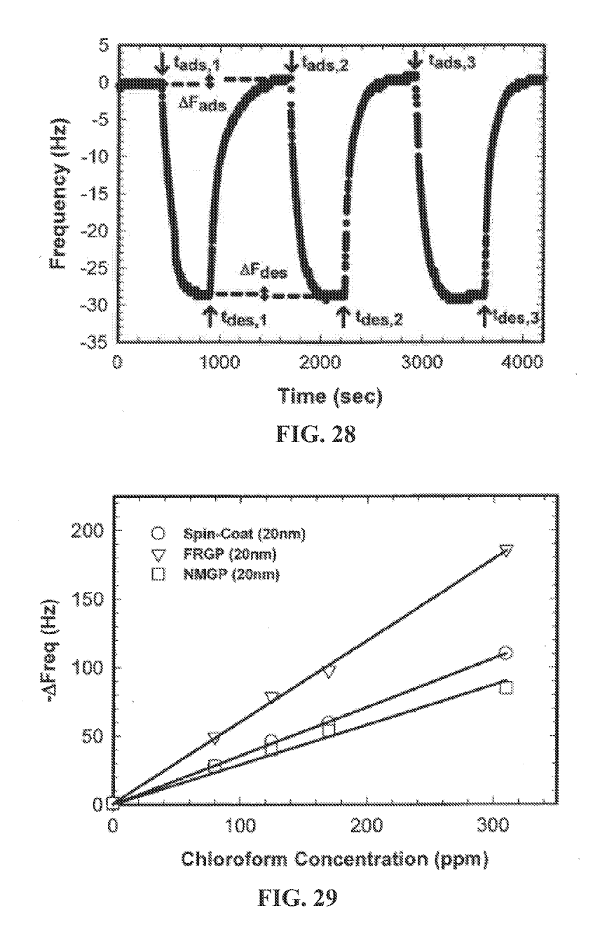

Sorption-desorption curves for 20 nm polymer layers formed by APPI-RI-FRGP (FIG. 27) and NMGP (FIG. 28) exhibited reproducible penetrant diffusion, resulting in a negligible mass change (Δₘ˜0). The reproducible penetrant sorption-desorption in the polymer layers was not surprising, given that swelling of covalently grafted polymer chains is not affected by the sample history, chain migration by Brownian motion, or polymer dewetting from the surface. However, it is also interesting to note that the negligible change in penetrant mass uptake suggests that the amorphous grafted polymer layers were not plasticized by the toluene penetrant. This was previously noted above which demonstrated the reproducible change in the film resistance with penetrant sorption-desorption.

The effect of the physical and chemical molecular properties of the penetrant on sorption and diffusion in grafted polymer films were demonstrated by comparing toluene and chloroform vapor transport in the thin films. The penetrant vapors were chosen based on their dissimilar chemistry and molecular size. Toluene is a non-polar molecule (dipole moment˜0.36), similar to polystyrene; chloroform is a polar molecular (dipole moment˜1.08). The preferential selectivity of the grafted polymer layer was noted in the decreased equilibrium sorption capacity of chloroform, compared to toluene vapor, in the grafted polymer layers (FIG. 29). The mass uptake ratio (i.e., penetrant selectivity) of chloroform at 170 ppm (Δf_{chi,170}) relative to toluene at 200 ppm (Δf_{tol,200}) was 1.22, 1.05, and 1.04 for polymer layers formed by APPI-RI-FRGP, APPI-NMGP, and spin-coating, respectively. The decreased penetrant selectivity for polymer layers formed by APPI-RI-FRGP, relative to spin-coated layers, was not surprising, given that for a similar penetrant-polymer chemical potential, sorption and diffusion into the polymer layer would be dictated by the layer porosity and the molecular penetrant size, as noted in the Free-Volume Theory. Then, it would be expected that polymer layers formed by APPI-NMGP and semi-crystalline spin-coated polymers, with a high packing efficiency and chain density, would have a similar solubility regardless of molecular penetrant size. This size exclusion mechanism of penetrant selectivity was observed in 8 form syndiotactic polystyrene which demonstrated a higher solubility for chloroform, relative to toluene. Similarly, the penetrant diffusivity for chloroform, relative to toluene, increased by more than two orders of magnitude for the spin-coated and grafted polymer layers (FIG. 30), which was again consistent for small molecule transport in polymer films.

Table 5 shows the partition coefficient (eq. VI.7) for toluene penetrant vapor equilibrium in 20 nm thick polystyrene films formed by spin-coating, APPI-RI-FRGP and AAPI-NMGP on aSi-QCM substrates (flow rate=50 mL/min, T=25° C.).

TABLE 5

| | Partition Coefficient, K | | |
|---|---|---|---|
| C_{A}= | 50 ppm | 120 ppm | 200 ppm |
| Spin-Coat (20 nm) | 24.91 | 33.81 | 40.57 |
| FRGP (20 nm) | 28.47 | 47.45 | 58.36 |
| NMGP (20 nm) | 31.31 | 32.62 | 35.94 |

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

What is claimed is:

1. A method of modifying a surface of a substrate, comprising:
activating the surface of the substrate; and
polymerizing the surface of the substrate, the polymerizing including subjecting the surface of the substrate to a monomer solution at a temperature of between 105° C. and 130° C. for a first period of time and subjecting the surface of the substrate to the monomer solution at a temperature of between 70° C. and 90° C. for a second period of time different than the first period of time.

2. The method of claim 1, wherein the monomer solution includes a vinyl monomer.

3. The method of claim 1, wherein the monomer solution includes a vinyl monomer and a solvent.

4. The method of claim 1, wherein the monomer solution is a mixture of styrene and chlorobenzene.

5. The method of claim 1, wherein the first period of time is shorter than the second period of time.

6. The method of claim 1, wherein the first time period and the second time period are optimized for the specific monomer solution.

7. The method of claim 1, wherein the first period of time is between 10 and 40 minutes, and the second period of time is between 20 and 30 hours.

8. The method of claim 1, wherein the activating the surface includes treating the surface of the substrate with an impinging atmospheric pressure plasma source.

9. The method of claim 1, wherein the substrate includes silicon.

10. A method of modifying a surface of a substrate, comprising:
activating the surface of the substrate; and
graft polymerizing a vinyl monomer onto the surface of the substrate, the polymerizing including subjecting the surface of the substrate to a mixture including a monomer solution and 2,2,6,6-tetramethyl-1-piperidinyloxy at a concentration of between 5 and 20 mM.

11. The method of claim 10, wherein the polymerizing includes subjecting the surface to the mixture at a temperature of between 70° C. and 140° C.

12. The method of claim 10, wherein the polymerizing includes subjecting the surface to the mixture for a time period of between 60 and 80 hours.

13. The method of claim 10, wherein the polymerizing includes subjecting the surface to the mixture at a temperature of about 120° C. and for a time period of about 72 hours.

14. The method of claim 10, wherein the concentration of 2,2,6,6-tetramethyl-1-piperidinyloxy is about 20 mM.

15. The method of claim 8, wherein the substrate includes silicon.

16. An apparatus, comprising:
a substrate having a surface, the surface having a set of polymers terminally graphed thereon, the apparatus being configured to sorb a chemical solute, the terminally grafter polymer layer being formed on the surface of the substrate by a controlled graft polymerization process.

17. The apparatus of claim 16, wherein the controlled polymerization process includes subjecting the surface of the substrate to a monomer solution at a first temperature for a first period of time and at a second temperature different than the first temperature for a second period of time different than the first period of time.

18. The apparatus of claim 16, wherein the controlled polymerization process includes subjecting the surface of the substrate to a monomer solution at a temperature between 105° C. and 115° C. for a period of time between 10 and 40 minutes.

19. The apparatus of claim 16, wherein the substrate includes silicon.
